(19) United States
(12) Patent Application Publication
(10) Pub. No.: US 2021/0118147 A1
(43) Pub. Date: Apr. 22, 2021

(54) DETECTION OF A SPLIT-SCREEN CONDITION

(71) Applicant: QUALCOMM Incorporated, San Diego, CA (US)

(72) Inventors: Ting Kin CHAN, Aurora (CA); Terence HO, Scarborough (CA); Alexander BARKAN, East Gwillimbury (CA); Rodrigo LOPEZ, Thornhill (CA); Syed Saaem Raza RIZVI, Brampton (CA); Jeffrey BERNARD, Keswick (CA); Abderahmane ALLALOU, Pickering (CA); Peter KOSTER, Toronto (CA)

(21) Appl. No.: 16/658,694

(22) Filed: Oct. 21, 2019

(51) Int. Cl. G06T 7/13; H04N 5/445; G06K 9/62

(52) U.S. Cl. CPC G06T 7/13; H04N 5/44591; G06T 2207/20081; G06T 2207/10016; G06T 2207/20084; G06K 9/6202

(57) ABSTRACT

Methods, systems, and devices for image processing are described. A device may determine a split-screen condition associated with a video image and perform an additional analysis to confirm the split-screen condition. In some examples, the device may generate a truncated image composed of one or more pixels located at each corner of a first image (e.g., a displayed image), and the device may process the truncated image to determine whether a split-screen condition is present for the displayed image. The device may use a continuality analysis, in which the device determines pixel values associated with multiple rows (or columns, or both) of a video image and compares differences between the pixel values at opposite ends of a video image to a threshold, to determine whether a split-screen condition is present. The device may then confirm a split-screen condition by processing the video image using an edge detection filter.

### BACKGROUND

The following relates generally to image processing, and more specifically to detection of a split-screen condition.

Multimedia systems are widely deployed to provide various types of multimedia communication content such as voice, video, packet data, messaging, broadcast, and so on. These multimedia systems may be capable of processing, storage, generation, manipulation and rendition of multimedia information. Examples of multimedia systems include entertainment systems, information systems, virtual reality systems, model and simulation systems, and so on. These systems may employ a combination of hardware and software technologies to support processing, storage, generation, manipulation and rendition of multimedia information, for example, such as capture devices, storage devices, communication networks, computer systems, and display devices.

### SUMMARY

The described techniques relate to improved methods, systems, devices, or apparatuses that support detection of a split-screen condition. A device may determine a split-screen condition associated with a video image (e.g., a displayed video image) and perform an additional analysis to confirm the split-screen condition. In some examples, the device may generate a truncated image composed of one or more pixels located at each corner of a first image (e.g., the device may generate a truncated image comprising edges or corners of a displayed image), and the device may process the truncated image to determine whether a split-screen condition is present (e.g., for the displayed image). In another example, the device may use a continuality analysis, in which the device determines pixel values associated with multiple rows (or columns, or both) of a video image and compares differences between the pixel values at opposite ends of a video image to a threshold, to determine whether a split-screen condition is present. In some cases, the device may then confirm a split-screen condition by processing the video image using an edge detection filter.

A method of image processing at a device is described. The method may include receiving a first image from an external source and generating a second image based on one or more pixels located at each corner of the first image. The method may further include processing, by a trained neural network, the second image, determining a split-screen condition associated with the first image based on the processing, and outputting an indication of the determined split-screen condition.

An apparatus for image processing at a device is described. The apparatus may include a processor, memory coupled with the processor, and instructions stored in the memory. The instructions may be executable by the processor to cause the apparatus to receive a first image from an external source and generate a second image based on one or more pixels located at each corner of the first image. The instructions may be executable by the processor to further cause the apparatus to process, by a trained neural network, the second image, determine a split-screen condition associated with the first image based on the processing, and output an indication of the determined split-screen condition.

Another apparatus for image processing at a device is described. The apparatus may include means for receiving a first image from an external source, generating a second image based on one or more pixels located at each corner of the first image, processing, by a trained neural network, the second image, determining a split-screen condition associated with the first image based on the processing, and outputting an indication of the determined split-screen condition.

A non-transitory computer-readable medium storing code for image processing at a device is described. The code may include instructions executable by a processor to receive a first image from an external source, generate a second image based on one or more pixels located at each corner of the first image, process, by a trained neural network, the second image, determine a split-screen condition associated with the first image based on the processing, and output an indication of the determined split-screen condition.

Some examples of the method, apparatuses, and non-transitory computer-readable medium described herein may further include operations, features, means, or instructions for processing the first image using an edge detection filter, where the split-screen condition may be determined based on the processing using the edge detection filter. In some examples of the method, apparatuses, and non-transitory computer-readable medium described herein, processing the first image using the edge detection filter may include operations, features, means, or instructions for converting pixels of one or more rows of the first image into white pixels, appending the white pixels to one or more pixel arrays, and comparing the one or more pixel arrays to a threshold, where the split-screen condition may be determined based on the comparison. In some examples of the method, apparatuses, and non-transitory computer-readable medium described herein, determining the split-screen condition may include operations, features, means, or instructions for determining a vertical split-screen condition based on the comparison, where the output indication may be indicative of the vertical split-screen condition.

In some examples of the method, apparatuses, and non-transitory computer-readable medium described herein, processing the first image using the edge detection filter may include operations, features, means, or instructions for converting pixels of one or more columns of the first image into white pixels, appending the white pixels to one or more pixel arrays, and comparing the one or more pixel arrays to a threshold, where the split-screen condition may be determined based on the comparison. In some examples of the method, apparatuses, and non-transitory computer-readable medium described herein, determining the split-screen condition may include operations, features, means, or instructions for determining a horizontal split-screen condition based on the comparison, where the output indication may be indicative of the horizontal split-screen condition.

In some examples of the method, apparatuses, and non-transitory computer-readable medium described herein, determining the split-screen condition includes: determining a horizontal split-screen condition associated with the first image, determining a vertical split-screen condition associated with the first image, or both, and processing the first image using the edge detection filter includes: performing an edge detection operation on one or more columns of pixels of the first image, performing an edge detection operation one or more rows of pixels of the first image, or both, based on the determined the split-screen condition.

Some examples of the method, apparatuses, and non-transitory computer-readable medium described herein may further include operations, features, means, or instructions for verifying the trained neural network based on the processing the using the edge detection filter. In some examples of the method, apparatuses, and non-transitory computer-readable medium described herein, the second image includes four quadrants, and each of the quadrants includes an array of one or more pixels from a respective corner of the first image.

In some examples of the method, apparatuses, and non-transitory computer-readable medium described herein, the split-screen condition may be determined based on a power consumption threshold of the device, a frequency threshold associated with the split-screen condition determination, a severity threshold associated with the split-screen condition determination, or some combination thereof. In some examples of the method, apparatuses, and non-transitory computer-readable medium described herein, determining the split-screen condition may include operations, features, means, or instructions for determining a horizontal split-screen condition associated with the first image, a vertical split-screen condition associated with the first image, or both, where the output indication may be indicative of the horizontal split-screen condition, the vertical split-screen condition, or both.

Some examples of the method, apparatuses, and non-transitory computer-readable medium described herein may further include operations, features, means, or instructions for receiving one or more images from the external source, and training the trained neural network based on the received one or more images. Some examples of the method, apparatuses, and non-transitory computer-readable medium described herein may further include operations, features, means, or instructions for receiving a retransmission of the first image from the external source based on the output indication of the determined split-screen condition, where the indication of the determined split-screen condition may be output to the external source.

A method of image processing at a device is described. The method may include receiving a first image from an external source, determining a difference between one or more pixel values of a first set of portions of the first image and one or more pixel values of a second set of portions of the first image, and comparing the difference to a threshold. The method may further include determining a split-screen condition associated with the first image based on the comparing and outputting an indication of the determined split-screen condition.

An apparatus for image processing at a device is described. The apparatus may include a processor, memory coupled with the processor, and instructions stored in the memory. The instructions may be executable by the processor to cause the apparatus to receive a first image from an external source, determine a difference between one or more pixel values of a first set of portions of the first image and one or more pixel values of a second set of portions of the first image, compare the difference to a threshold, determine a split-screen condition associated with the first image based on the comparing, and output an indication of the determined split-screen condition.

Another apparatus for image processing at a device is described. The apparatus may include means for receiving a first image from an external source, determining a difference between one or more pixel values of a first set of portions of the first image and one or more pixel values of a second set of portions of the first image, comparing the difference to a threshold, determining a split-screen condition associated with the first image based on the comparing, and outputting an indication of the determined split-screen condition.

A non-transitory computer-readable medium storing code for image processing at a device is described. The code may include instructions executable by a processor to receive a first image from an external source, determine a difference between one or more pixel values of a first set of portions of the first image and one or more pixel values of a second set of portions of the first image, compare the difference to a threshold, determine a split-screen condition associated with the first image based on the comparing, and output an indication of the determined split-screen condition.

Some examples of the method, apparatuses, and non-transitory computer-readable medium described herein may further include operations, features, means, or instructions for processing the first image using an edge detection filter, where the split-screen condition may be determined based on the processing using the edge detection filter. In some examples of the method, apparatuses, and non-transitory computer-readable medium described herein, processing the first image using the edge detection filter may include operations, features, means, or instructions for converting pixels of one or more rows of the first image into white pixels, appending the white pixels to one or more pixel arrays, and comparing the one or more pixel arrays to a threshold, where the split-screen condition may be determined based on the comparison.

In some examples of the method, apparatuses, and non-transitory computer-readable medium described herein, determining the split-screen condition may include operations, features, means, or instructions for determining a vertical split-screen condition based on the comparison, where the output indication may be indicative of the vertical split-screen condition. In some examples of the method, apparatuses, and non-transitory computer-readable medium described herein, processing the first image using the edge detection filter may include operations, features, means, or instructions for converting pixels of one or more columns of the first image into white pixels, appending the white pixels to one or more pixel arrays, and comparing the one or more pixel arrays to a threshold, where the split-screen condition may be determined based on the comparison.

In some examples of the method, apparatuses, and non-transitory computer-readable medium described herein, determining the split-screen condition may include operations, features, means, or instructions for determining a horizontal split-screen condition based on the comparison, where the output indication may be indicative of the horizontal split-screen condition. In some examples of the method, apparatuses, and non-transitory computer-readable medium described herein, determining the split-screen condition includes: determining a horizontal split-screen condition associated with the first image, determining a vertical split-screen condition associated with the first image, or both, and processing the first image using the edge detection filter includes: performing an edge detection operation on one or more columns of pixels of the first image, performing an edge detection operation one or more rows of pixels of the first image, or both, based on the determined the split-screen condition.

In some examples of the method, apparatuses, and non-transitory computer-readable medium described herein, determining the difference between the one or more pixel values of the first set of portions of the first image and the one or more pixel values of the second set of portions of the first image may include operations, features, means, or instructions for determining a sum of differences squared between the one or more pixel values of the first set of portions of the first image and the one or more pixel values of the second set of portions of the first image, normalizing the determined sum of differences squared based on a dimension size of the first image, and performing one or more convolution calculations based on at least in part on the normalized sum.

In some examples of the method, apparatuses, and non-transitory computer-readable medium described herein, determining the difference between the one or more pixel values of the first set of portions of the first image and the one or more pixel values of the second set of portions of the first image may include operations, features, means, or instructions for determining a difference between one or more pixel values of a first set of one or more rows of the first image and one or more pixel values of a second set of one or more rows of the first image, where the determined split-screen condition includes a horizontal split-screen condition.

In some examples of the method, apparatuses, and non-transitory computer-readable medium described herein, determining the difference between the one or more pixel values of the first set of portions of the first image and the one or more pixel values of the second set of portions of the first image may include operations, features, means, or instructions for determining a difference between one or more pixel values of a first set of one or more columns of the first image and one or more pixel values of a second set of one or more columns of the first image, where the determined split-screen condition includes a vertical split-screen condition.

In some examples of the method, apparatuses, and non-transitory computer-readable medium described herein, the split-screen condition may be determined based on a power consumption threshold of the device, a frequency threshold associated with the split-screen condition determination, a severity threshold associated with the split-screen condition determination, or some combination thereof. In some examples of the method, apparatuses, and non-transitory computer-readable medium described herein, determining the split-screen condition may include operations, features, means, or instructions for determining a horizontal split-screen condition associated with the first image, a vertical split-screen condition associated with the first image, or both, where the output indication may be indicative of the horizontal split-screen condition, the vertical split-screen condition, or both. Some examples of the method, apparatuses, and non-transitory computer-readable medium described herein may further include operations, features, means, or instructions for receiving a retransmission of the first image from the external source based on the output indication of the determined split-screen condition.

A method of image processing at a device is described. The method may include receiving a first image from an external source, generating a second image based on one or more pixels located at each corner of the first image, and processing, by a trained neural network, the second image. The method may further include determining a difference between one or more pixel values of a first set of portions of the first image and one or more pixel values of a second set of portions of the first image and comparing the difference to a threshold. The method may further include determining the split-screen condition based on the processing of the second image by the trained neural network, the comparison of the difference to the threshold, or both, and outputting an indication of the determined split-screen condition.

An apparatus for image processing at a device is described. The apparatus may include a processor, memory coupled with the processor, and instructions stored in the memory. The instructions may be executable by the processor to cause the apparatus to receive a first image from an external source, generate a second image based on one or more pixels located at each corner of the first image, process, by a trained neural network, the second image, determine a difference between one or more pixel values of a first set of portions of the first image and one or more pixel values of a second set of portions of the first image, compare the difference to a threshold, determine the split-screen condition based on the processing of the second image by the trained neural network, the comparison of the difference to the threshold, or both, and output an indication of the determined split-screen condition.

Another apparatus for image processing at a device is described. The apparatus may include means for receiving a first image from an external source, generating a second image based on one or more pixels located at each corner of the first image, processing, by a trained neural network, the second image, determining a difference between one or more pixel values of a first set of portions of the first image and one or more pixel values of a second set of portions of the first image, comparing the difference to a threshold, determining the split-screen condition based on the processing of the second image by the trained neural network, the comparison of the difference to the threshold, or both, and outputting an indication of the determined split-screen condition.

A non-transitory computer-readable medium storing code for image processing at a device is described. The code may include instructions executable by a processor to receive a first image from an external source, generate a second image based on one or more pixels located at each corner of the first image, process, by a trained neural network, the second image, determine a difference between one or more pixel values of a first set of portions of the first image and one or more pixel values of a second set of portions of the first image, compare the difference to a threshold, determine the split-screen condition based on the processing of the second image by the trained neural network, the comparison of the difference to the threshold, or both, and output an indication of the determined split-screen condition.

A method of image processing at a device is described. The method may include receiving a first image from an external source, generating a second image based on one or more pixels located at each corner of the first image, and processing, by a trained neural network, the second image. The method may include determining a difference between one or more pixel values of a first set of portions of the first image and one or more pixel values of a second set of portions of the first image and comparing the difference to a threshold. The method may include processing the first image using an edge detection filter based on the processing of the second image by the trained neural network, the comparison of the difference to the threshold, or both. The method may include determining the split-screen condition based on the processing using the edge detection filter and outputting an indication of the determined split-screen condition.

An apparatus for image processing at a device is described. The apparatus may include a processor, memory coupled with the processor, and instructions stored in the memory. The instructions may be executable by the processor to cause the apparatus to receive a first image from an external source, generate a second image based on one or more pixels located at each corner of the first image, process, by a trained neural network, the second image, determine a difference between one or more pixel values of a first set of portions of the first image and one or more pixel values of a second set of portions of the first image, compare the difference to a threshold, process the first image using an edge detection filter based on the processing of the second image by the trained neural network, the comparison of the difference to the threshold, or both, determine the split-screen condition based on the processing using the edge detection filter, and output an indication of the determined split-screen condition.

Another apparatus for image processing at a device is described. The apparatus may include means for receiving a first image from an external source, generating a second image based on one or more pixels located at each corner of the first image, processing, by a trained neural network, the second image, determining a difference between one or more pixel values of a first set of portions of the first image and one or more pixel values of a second set of portions of the first image, comparing the difference to a threshold, processing the first image using an edge detection filter based on the processing of the second image by the trained neural network, the comparison of the difference to the threshold, or both, determining the split-screen condition based on the processing using the edge detection filter, and outputting an indication of the determined split-screen condition.

A non-transitory computer-readable medium storing code for image processing at a device is described. The code may include instructions executable by a processor to receive a first image from an external source, generate a second image based on one or more pixels located at each corner of the first image, process, by a trained neural network, the second image, determine a difference between one or more pixel values of a first set of portions of the first image and one or more pixel values of a second set of portions of the first image, compare the difference to a threshold, process the first image using an edge detection filter based on the processing of the second image by the trained neural network, the comparison of the difference to the threshold, or both, determine the split-screen condition based on the processing using the edge detection filter, and output an indication of the determined split-screen condition.

### BRIEF DESCRIPTION OF THE DRAWINGS

FIG. 1 illustrates an example of a system that supports detection of a split-screen condition in accordance with aspects of the present disclosure.

FIG. 2 illustrates an example of a device that supports detection of a split-screen condition in accordance with aspects of the present disclosure.

FIGS. 3A through 3C illustrate example split-screen detection diagrams that support detection of a split-screen condition in accordance with aspects of the present disclosure

FIG. 4 illustrates an example of an image processing diagram that supports detection of a split-screen condition in accordance with aspects of the present disclosure.

FIG. 5 illustrates an example of an image processing diagram that supports detection of a split-screen condition in accordance with aspects of the present disclosure.

FIG. 6 illustrates a block diagram of a device that supports detection of a split-screen condition in accordance with aspects of the present disclosure.

FIGS. 7 and 8 show block diagrams of devices that support detection of a split-screen condition in accordance with aspects of the present disclosure.

FIG. 9 shows a block diagram of a display manager that supports detection of a split-screen condition in accordance with aspects of the present disclosure.

FIG. 10 shows a diagram of a system including a device that supports detection of a split-screen condition in accordance with aspects of the present disclosure.

FIGS. 11 through 13 show flowcharts illustrating methods that support detection of a split-screen condition in accordance with aspects of the present disclosure.

### DETAILED DESCRIPTION

When an external video source component (e.g., a camera, image sensor, etc.) transmits video images to a processor system on chip (SOC) of a device displaying video, frame loss during the transmission may result in a split-screen condition at the display of the device. For example, vertical and/or horizontal splitting of the video image, frame misalignment, etc. may arise from frame loss (e.g., packet loss) during transmission from the external source to the display. Frame loss may occur due to errors in data transmission, where one or more packets or frames of data transmitted from the external source (e.g., across a computer network, a wireless network, a wired link, etc.) fail to reach an intended destination (e.g., to a device capable of displaying images associated with the data). In some cases, frame loss may be measured as a percentage of packets lost with respect to packets sent. In some aspects, frame loss may refer to partial frame loss or full frame loss (e.g., portions or entireties of frame data may be lost during transmission from the external source), and such frame loss may result in misaligned video frame buffering, a corrupted display signal, etc. For example, in some cases, frame loss may result in a split-screen condition (e.g., where missing frame information or misaligned video frame buffering results in a displayed image being undesirably split vertically, horizontally, or both). In some instances, a user viewing displayed video images of a physical environment (e.g., vehicle rear-view camera images) may be unable to correctly assess the physical environment under such split-screen conditions (e.g., the user may be unaware of, or disoriented as to the location of, hazards in the physical environment).

According to the techniques described herein, a device may determine a split-screen condition associated with a video image (e.g., a displayed video image) and perform an additional analysis to confirm the split-screen condition. In some examples, the device may generate a truncated image composed of one or more pixels located at each corner of a first image (e.g., the device may generate a truncated image comprising edges or corners of a displayed image), and the device may process the truncated image to determine whether a split-screen condition is present (e.g., for the displayed image). In another example, the device may use a continuality analysis, in which the device determines pixel values associated with multiple rows (or columns, or both) of a video image and compares differences between the pixel values at opposite ends of a video image to a threshold, to determine whether a split-screen condition is present. In some cases, the device may then confirm a split-screen condition by processing the video image using an edge detection filter.

Particular aspects of the subject matter described herein may be implemented to realize one or more advantages. Implementation of the described techniques may provide for detection of a split-screen condition, among other advantages. As such, supported techniques may include features for alerting a user of a split-screen condition, so as to improve user safety. Additionally, the improved techniques may provide for correcting the split-screen condition, which may improve user experience and reliability of safety applications. The improved techniques may include features for utilizing a trained neural network in detecting a split-screen condition, which may further improve the reliability and accuracy of detection and related safety applications.

Aspects of the disclosure are initially described in the context of a multimedia system. Example split-screen detection diagrams and image processing diagrams illustrating aspects of the discussed techniques are then described. Aspects of the disclosure are further illustrated by and described with reference to apparatus diagrams, system diagrams, and flowcharts that relate to detection of a split-screen condition.

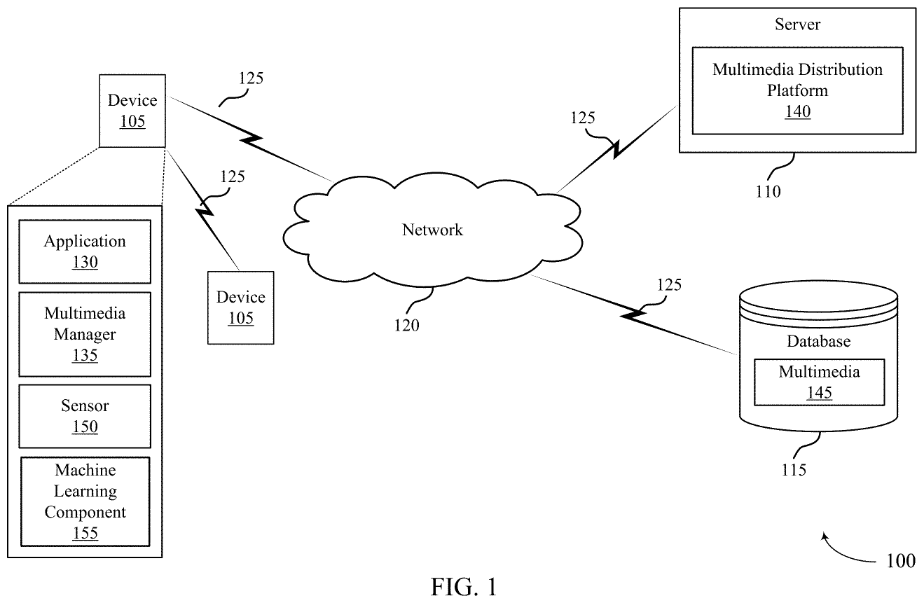

FIG. 1 illustrates a multimedia system 100 that supports detecting a split-screen condition in accordance with aspects of the present disclosure. The multimedia system 100 may include devices 105, a server 110, and a database 115. Although, the multimedia system 100 illustrates two devices 105, a single server 110, a single database 115, and a single network 120, the present disclosure may apply to any multimedia system architecture having one or more devices 105, servers 110, databases 115, and networks 120. The devices 105, the server 110, and the database 115 may communicate with each other and exchange information that supports detecting a split-screen condition, such as multimedia packets, multimedia data, or multimedia control information, via network 120 using communications links 125. In some cases, a portion or all of the techniques described herein supporting detection of a split-screen condition may be performed by the devices 105 or the server 110, or both.

A device 105 may be a cellular phone, a smartphone, a personal digital assistant (PDA), a wireless communication device, a handheld device, a tablet computer, a laptop computer, a cordless phone, a display device (e.g., monitors), and/or the like that supports various types of communication and functional features related to multimedia (e.g., transmitting, receiving, broadcasting, streaming, sinking, capturing, storing, and recording multimedia data). A device 105 may, additionally or alternatively, be referred to by those skilled in the art as a user equipment (UE), a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 105 may be able to communicate directly with another device (e.g., using a peer-to-peer (P2P) or device-to-device (D2D) protocol). For example, a device 105 may be able to receive from or transmit to another device 105 variety of information, such as instructions or commands (e.g., multimedia-related information).

In some examples, the devices 105 may be stationary or mobile. In some examples, devices 105 may include automotive vehicles, aerial vehicles, such as an unmanned aerial vehicles (UAVs), drones, etc., ground vehicles and robots (e.g., autonomous or semi-autonomous cars, vacuum robots, search and rescue robots, bomb detection and disarming robots), water-based vehicles (i.e., surface watercraft and submarines), space-based vehicles (e.g., a spacecraft or space probe), or some combination thereof. Various embodiments may be particularly useful for the device 105 configured as part of an advanced driver-assistance systems (ADAS), a driver-assistance camera, etc.

The devices 105 may include an application 130 and a multimedia manager 135. While, the multimedia system 100 illustrates the devices 105 including both the application 130 and the multimedia manager 135, the application 130 and the multimedia manager 135 may be an optional feature for the devices 105. In some cases, the application 130 may be a multimedia-based application that can receive (e.g., download, stream, broadcast) from the server 110, database 115 or another device 105, or transmit (e.g., upload) multimedia data to the server 110, the database 115, or to another device 105 via using communications links 125.

The devices 105 may include or be coupled to a sensor 150. The sensor 150 may be a camera device, a standalone camera, a digital camera, a stereo camera, an image sensor, or the like that may be integrated with or separate from a device 105. The sensor 150 may transmit images (e.g., still images, video images, video streams) or audio signals (e.g., audio recordings, audio streams) to the device 105, via wired or wireless connections (e.g., Wi-Fi, Bluetooth, Bluetooth low-energy (BLE), cellular, Z-WAVE, 802.11, peer-to-peer, LAN, wireless local area network (WLAN), Ethernet, FireWire, fiber optic). In some examples, the device 105 may support multiple sensors 150. The sensor 150 may have one or more sensors for example, such as a charge coupled device (CCD) sensor or a complementary metal-oxide semiconductor (CMOS) sensor. In some examples, the sensor 150 may capture a set of images of a physical environment (e.g., a multi-dimensional space) or a multi-dimensional object in the environment. In some aspects, the device 105 may use the images in training and verifying learning models (e.g., machine learning models) applicable to detecting a split-screen condition. The techniques described herein may support autonomous or semi-autonomous functions related to, for example, ADAS or driver-assistance cameras (e.g., rear view cameras, side view cameras, side mirror cameras, front view cameras (e.g., dashboard view cameras), around view cameras, driver monitors). In some example aspects, the techniques described herein may support detecting a split-screen condition associated with ADAS or driver-assistance cameras. The techniques may verify or detect the presence of a multi-dimensional object (e.g., road hazard, a vehicle, a person) proximate to the device 105 with a high degree of accuracy.

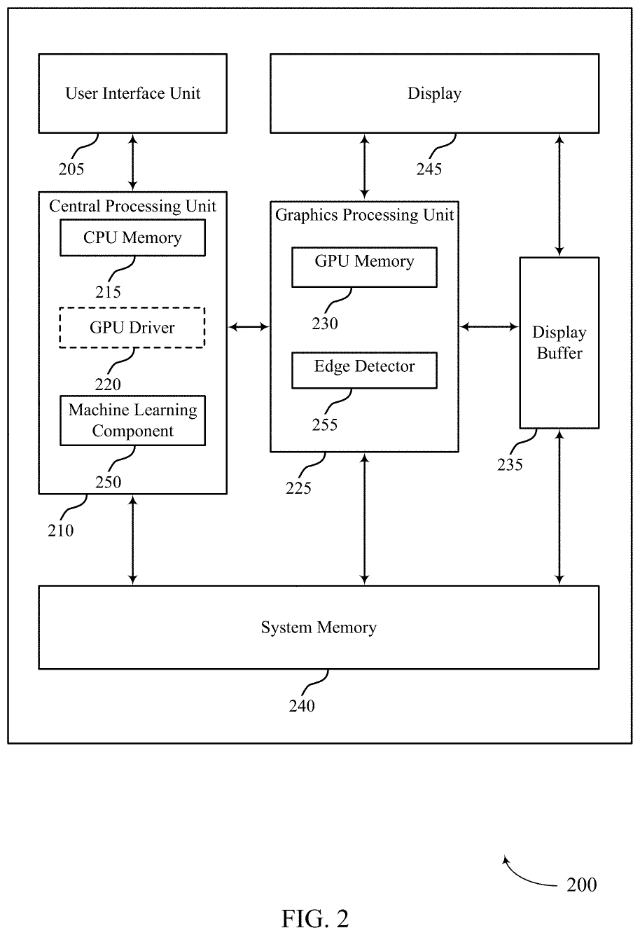

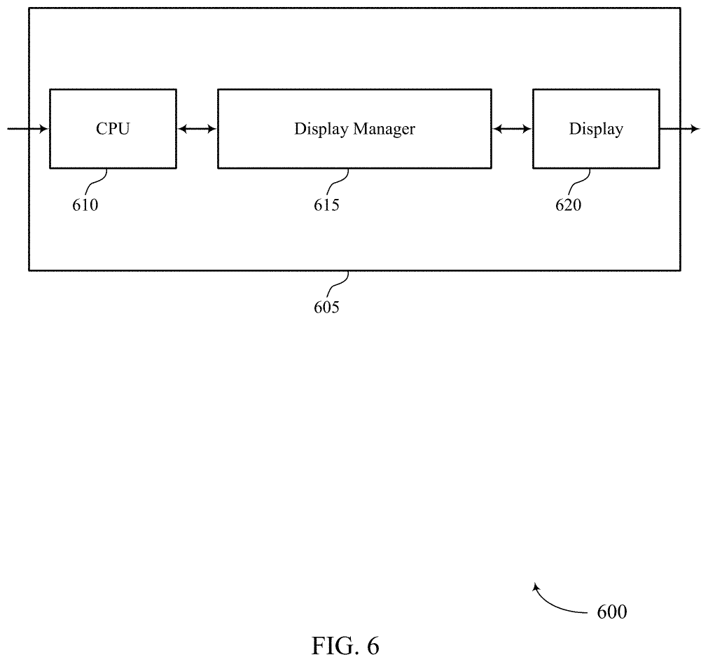

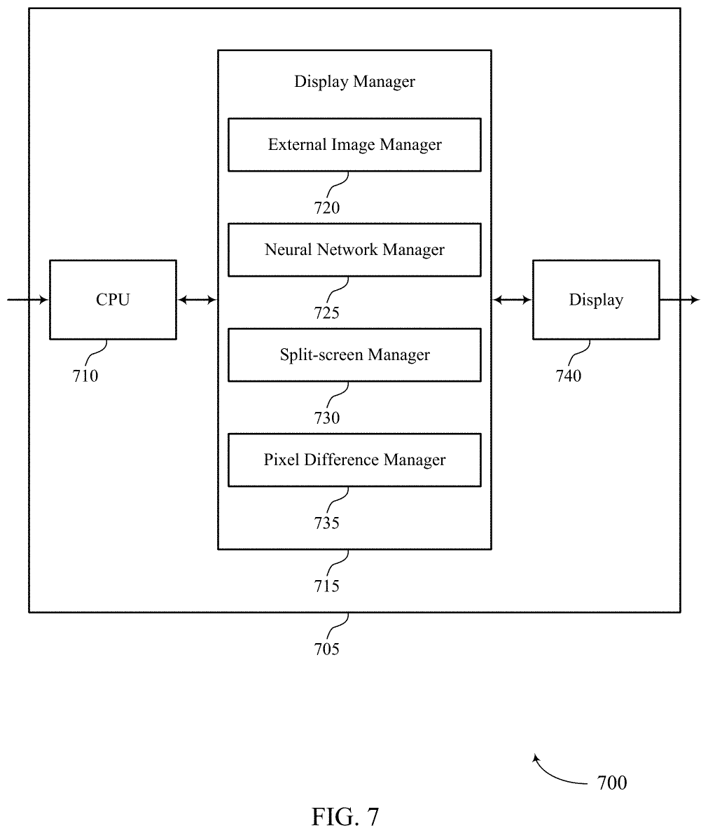

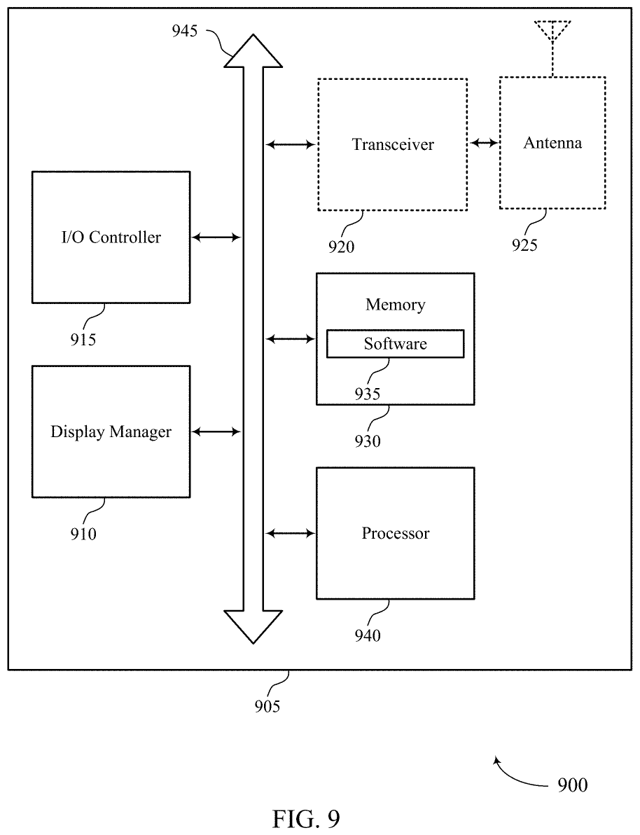

The device 105 may include a machine learning component 155. The machine learning component 155 may be implemented by aspects of a processor, for example, such as Central Processing Unit (CPU) 210 described in FIG. 2, CPU 610 described in FIG. 6, or CPU 710 described in FIG. 7, or processor 940 described in FIG. 9. The machine learning component 155 may include a machine learning network (e.g., a neural network, a deep neural network, a convolutional neural network, a trained neural network, etc.).

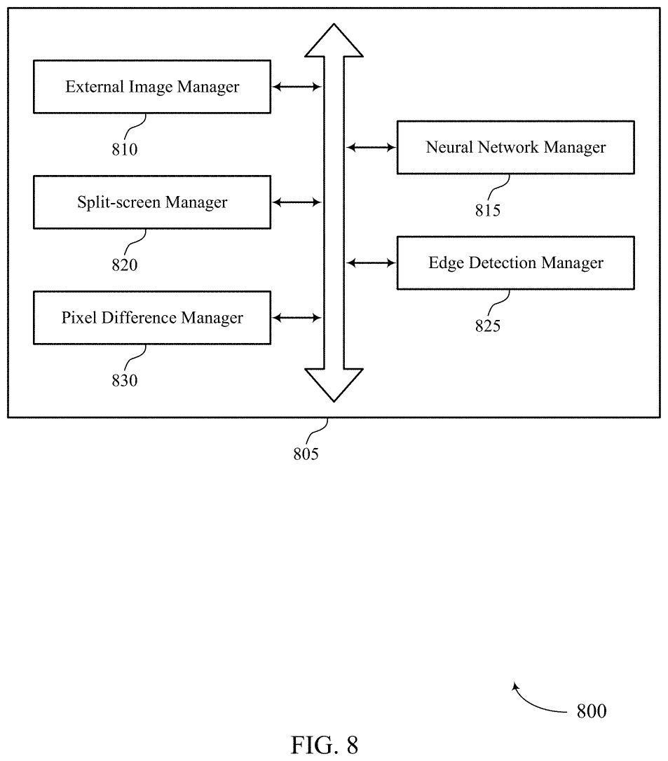

The multimedia manager 135 may be part of a general-purpose processor, a digital signal processor (DSP), an image signal processor (ISP), a central processing unit (CPU), a graphics processing unit (GPU), a microcontroller, an application-specific integrated circuit (ASIC), a field-programmable gate array (FPGA), a discrete gate or transistor logic component, a discrete hardware component, or any combination thereof, or other programmable logic device, discrete gate or transistor logic, discrete hardware components, or any combination thereof designed to perform the functions described in the present disclosure, and/or the like. For example, the multimedia manager 135 may process multimedia (e.g., image data, video data, audio data) from and/or write multimedia data to a local memory of the device 105 or to the database 115. In some cases, the multimedia manager 135 may include or refer to aspects of a display manager, for example, such as display manager 615 described in FIG. 6, display manager 715 described in FIG. 7, display manager 805 described in FIG. 8, or display manager 910 described in FIG. 9.

The multimedia manager 135 may also be configured to provide multimedia enhancements, multimedia restoration, multimedia analysis, multimedia compression, multimedia streaming, and multimedia synthesis, among other functionality. For example, the multimedia manager 135 may perform white balancing, cropping, scaling (e.g., multimedia compression), adjusting a resolution, multimedia stitching, color processing, multimedia filtering, spatial multimedia filtering, artifact removal, frame rate adjustments, multimedia encoding, multimedia decoding, and multimedia filtering. By further example, the multimedia manager 135 may process multimedia data to support shader controlled wave scheduling priority, according to the techniques described herein.

The server 110 may be a data server, a cloud server, a server associated with an multimedia subscription provider, proxy server, web server, application server, communications server, home server, mobile server, or any combination thereof. The server 110 may in some cases include a multimedia distribution platform 140. The multimedia distribution platform 140 may allow the devices 105 to discover, browse, share, and download multimedia via network 120 using communications links 125, and therefore provide a digital distribution of the multimedia from the multimedia distribution platform 140. As such, a digital distribution may be a form of delivering media content such as audio, video, images, without the use of physical media but over online delivery mediums, such as the Internet. For example, the devices 105 may upload or download multimedia-related applications for streaming, downloading, uploading, processing, enhancing, etc. multimedia (e.g., images, audio, video). The server 110 may also transmit to the devices 105 a variety of information, such as instructions or commands (e.g., multimedia-related information) to download multimedia-related applications on the device 105.

The database 115 may store a variety of information, such as instructions or commands (e.g., multimedia-related information). For example, the database 115 may store multimedia 145. The device may support shader controlled wave scheduling priority associated with the multimedia 145. The device 105 may retrieve the stored data from the database 115 via the network 120 using communication links 125. In some examples, the database 115 may be a relational database (e.g., a relational database management system (RDBMS) or a Structured Query Language (SQL) database), a non-relational database, a network database, an object-oriented database, or other type of database, that stores the variety of information, such as instructions or commands (e.g., multimedia-related information).

The network 120 may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)), etc. Network 120 may include the Internet.

The communications links 125 shown in the multimedia system 100 may include uplink transmissions from the device 105 to the server 110 and the database 115, and/or downlink transmissions, from the server 110 and the database 115 to the device 105. The communication links 125 may transmit bidirectional communications and/or unidirectional communications. In some examples, the communication links 125 may be a wired connection or a wireless connection, or both. For example, the communications links 125 may include one or more connections, including but not limited to, Wi-Fi, Bluetooth, BLE, cellular, Z-WAVE, 802.11, peer-to-peer, LAN, WLAN, Ethernet, FireWire, fiber optic, and/or other connection types related to wireless communication systems.

Techniques for detecting a split-screen condition associated with video images are proposed. A device may determine a split-screen condition associated with a video image (e.g., a displayed video image) and perform an additional analysis to confirm the split-screen condition. In some examples, the device may generate a truncated image composed of one or more pixels located at locations (e.g., each corner, each edge, etc.) of a first image (e.g., the device may generate a truncated image comprising edges or corners of a displayed image or of an image to be displayed). The device may then process (e.g., via a machine learning network, for example, such as a convolutional neural network) the truncated image to determine whether a split-screen condition is present (e.g., to determine whether the displayed video image is associated with a split-screen condition). In another example, the device may use a continuality analysis, in which the device determines pixel values associated with multiple rows (or columns, or both) of a video image and compares differences between the pixel values at opposite ends of the video image to a threshold, to determine whether a split-screen condition is present. In some cases, the device may then confirm a split-screen condition by processing the video image using an edge detection filter (e.g., where locations of white pixels in the multiple rows or columns are appended to arrays and compared).

The techniques described herein may provide improvements in detection of a split-screen condition. Furthermore, the techniques described herein may provide benefits and enhancements to the operation of the devices 105. For example, by determining a split-screen condition using a truncated image, the operational characteristics, such as power consumption, processor utilization (e.g., DSP, CPU, GPU, ISP processing utilization), and memory usage of the devices 105 may be reduced (e.g., as detection and correction of a split screen condition may avoid system reconfiguration procedures or system rebooting procedures). The techniques described herein may also provide for downsampling image data (e.g., via a combination of convolutional layers and pooling layers) to be processed, which may improve efficiency to the devices 105 by reducing latency associated with processes related to determining a split-screen condition.

FIG. 2 illustrates an example of a device 200 in accordance with various aspects of the present disclosure. In some cases, device 200 may implement or perform aspects of techniques for detection of a split-screen condition as described with reference to FIG. 1. Examples of a device 200 include, but are not limited to, wireless devices, mobile or cellular telephones, including smartphones, PDAs, vehicles (e.g., vehicle rear-view imaging devices or systems), video gaming consoles that include video displays, mobile video gaming devices, mobile video conferencing units, laptop computers, desktop computers, televisions set-top boxes, tablet computing devices, e-book readers, fixed or mobile media players, and the like.

In the example of FIG. 2, device 200 includes CPU 210 having CPU memory 215, a GPU 225 having GPU memory 230, a display 245, a display buffer 235 storing data associated with rendering, a user interface unit 205, and a system memory 240. For example, system memory 240 may store a GPU driver 220 (illustrated as being contained within CPU 210 as described herein) having a compiler, a GPU program, a locally-compiled GPU program, and the like. User interface unit 205, CPU 210, GPU 225, system memory 240, and display 245 may communicate with each other (e.g., using a system bus).

CPU 210 may include a machine learning component 250. The machine learning component 250 may be an example of aspects of the machine learning component 155 described herein. The machine learning component 250 may include a machine learning network (e.g., a neural network, a deep neural network, a convolutional neural network, a trained neural network). In some examples, the machine learning component 250 may include one or more layers (e.g., neural network layers, convolution layers). In some examples, the machine learning component 250 may receive one or more input signals at an input layer or a first layer and provide output signals via an output layer or a last layer. The machine learning component 250 may process the one or more input signals, for example, utilizing one or more intermediate layers (e.g., one or more intermediate hidden layers). In some examples, each of the layers of the machine learning component 250 may include one or more nodes (e.g., one or more neurons) arranged therein and may provide one or more activation functions. In some examples, the machine learning component 250 may include layers of convolution filters followed by a pooling layer (e.g., a maximum pooling layer) and a layer of perceptrons (e.g., a fully connected layer of perceptrons).

The machine learning component 250 may also include connections (e.g., edges, paths) between the one or more nodes included in adjacent layers. Each of the connections may have an associated weight (e.g., a weighting factor, a weighting coefficient). The weights, for example, may be assignable by the machine learning component 250. In some examples, the machine learning component 250 may include one or more shortcut paths via which the machine learning component 250 may bypass any of the intermediate layers. In some examples, the device 200 may train and implement the machine learning component 250 at various processing stages to provide processing improvements (e.g., application processing) or verification improvements (e.g., determining of a split-screen condition, verification of a determined split-screen condition). For example, the device 200 may train and implement the machine learning component 250 to improve processing efficiency while determining a split-screen condition or verifying a determined split-screen condition. In some cases, the machine learning component 250 may be trained using artificial images or training images with a split screen condition, as well as using artificial images or training images without a split screen condition (e.g., such that the machine learning component 250 may effectively process a truncated image or a displayed image to detect a split-screen condition).

Examples of CPU 210 include, but are not limited to, a DSP, general purpose microprocessor, ASIC, FPGA, or other equivalent integrated or discrete logic circuitry. Although CPU 210 and GPU 225 are illustrated as separate units in the example of FIG. 2, in some examples, CPU 210 and GPU 225 may be integrated into a single unit. CPU 210 may execute one or more software applications. Examples of the applications may include operating systems, word processors, web browsers, e-mail applications, spreadsheets, video games, audio and/or video capture, playback or editing applications, or other such applications that initiate the generation of image data to be presented via display 245. In an example, CPU memory 215 may represent on-chip storage or memory used in executing machine or object code. CPU memory 215 may include one or more volatile or non-volatile memories or storage devices, such as flash memory, a magnetic data media, an optical storage media, etc. CPU 210 may be able to read values from or write values to CPU memory 215 more quickly than reading values from or writing values to system memory 240, which may be accessed, e.g., over a system bus.

GPU 225 may represent one or more dedicated processors for performing graphical operations. That is, for example, GPU 225 may be a dedicated hardware unit having fixed function and programmable components for rendering graphics and executing GPU applications. GPU 225 may also include a DSP, a general purpose microprocessor, an ASIC, an FPGA, or other equivalent integrated or discrete logic circuitry. GPU 225 may be built with a highly-parallel structure that provides more efficient processing of complex graphic-related operations than CPU 210. For example, GPU 225 may include a plurality of processing elements that are configured to operate on multiple vertices or pixels in a parallel manner. The highly parallel nature of GPU 225 may allow GPU 225 to generate graphic images (e.g., graphical user interfaces and two-dimensional or three-dimensional graphics scenes) for display 245 more quickly than CPU 210.

GPU 225 may include an edge detector 255. Edge detector 255 may be capable of performing edge detection operations for identifying discontinuities in an image (e.g., a digital image, a frame of a digital video image). In some aspects, edge detector 255 may identify points or a series of points (e.g., edges) in the digital image where changes in image brightness (e.g., transitions in pixel brightness) satisfy a threshold (e.g., exceed a threshold, are below a threshold). Edge detector 255 may apply one or more detection techniques (e.g., which, in some cases, may include or refer to implementation of one or more detection algorithms) for processing an image. In some aspects, the detection techniques may filter out partial or complete amounts of information or data from an image, reducing an amount of data to be processed by GPU 225 with respect to the image. In some aspects, edge detector 255 may apply an edge detection filter. The edge detection filter may convert one or more pixels included in edges of the image (e.g., edge pixels) into white pixels (e.g., set the pixel values to white, for example, to a Red Green Blue (RGB) pixel value of (255, 255, 255)). In some examples, the edge detection filter may convert pixels other than edge pixels into black pixels (e.g., set the pixel values to black, for example, to an RGB pixel value of 0, 0, 0). In some cases, the converted pixels may then be analyzed to determine if a split-screen condition is present (e.g., if an edge is detected in the form of a vertical or horizontal line indicative of a split screen).

GPU 225 may, in some instances, be integrated into a motherboard of device 200. In other instances, GPU 225 may be present on a graphics card that is installed in a port in the motherboard of device 200 or may be otherwise incorporated within a peripheral device configured to interoperate with device 200. As illustrated, GPU 225 may include GPU memory 230. For example, GPU memory 230 may represent on-chip storage or memory used in executing machine or object code. GPU memory 230 may include one or more volatile or non-volatile memories or storage devices, such as flash memory, a magnetic data media, an optical storage media, etc. GPU 225 may be able to read values from or write values to GPU memory 230 more quickly than reading values from or writing values to system memory 240, which may be accessed, e.g., over a system bus. That is, GPU 225 may read data from and write data to GPU memory 230 without using the system bus to access off-chip memory. This operation may allow GPU 225 to operate in a more efficient manner by reducing the amount of data read or written by GPU 225 via the system bus, which may experience heavy bus traffic.

Display 245 represents a unit capable of displaying video, images, text or any other type of data for consumption by a viewer. Display 245 may include a liquid-crystal display (LCD), a light emitting diode (LED) display, an organic LED (OLED), an active-matrix OLED (AMOLED), or the like. Display buffer 235 represents a memory or storage device dedicated to storing data for presentation of imagery, such as computer-generated graphics, still images, video frames, or the like for display 245. Display buffer 235 may represent a two-dimensional buffer that includes a plurality of storage locations. The number of storage locations within display buffer 235 may, in some cases, generally correspond to the number of pixels to be displayed on display 245. For example, if display 245 is configured to include 640×480 pixels, display buffer 235 may include 640×480 storage locations storing pixel color and intensity information, such as red, green, and blue pixel values, or other color values. Display buffer 235 may store the final pixel values for each of the pixels processed by GPU 225. Display 245 may retrieve the final pixel values from display buffer 235 and display the final image based on the pixel values stored in display buffer 235.

User interface unit 205 represents a unit with which a user may interact or otherwise interface to communicate with other units of device 200, such as CPU 210. Examples of user interface unit 205 include, but are not limited to, a trackball, a mouse, a keyboard, and other types of input devices. User interface unit 205 may also be, or include, a touch screen and the touch screen may be incorporated as part of display 245.

System memory 240 may comprise one or more computer-readable storage media. Examples of system memory 240 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 240 may store program modules and/or instructions that are accessible for execution by CPU 210. Additionally, system memory 240 may store user applications and application surface data associated with the applications. System memory 240 may in some cases store information for use by and/or information generated by other components of device 200. For example, system memory 240 may act as a device memory for GPU 225 and may store data to be operated on by GPU 225 as well as data resulting from operations performed by GPU 225

In some examples, system memory 240 may include instructions that cause CPU 210 or GPU 225 to perform the functions ascribed to CPU 210 or GPU 225 in aspects of the present disclosure. System memory 240 may, in some examples, be considered as a non-transitory storage medium. The term “non-transitory” should not be interpreted to mean that system memory 240 is non-movable. As one example, system memory 240 may be removed from device 200 and moved to another device. As another example, a system memory substantially similar to system memory 240 may be inserted into device 200. In some examples, a non-transitory storage medium may store data that can, over time, change (e.g., in RAM).

System memory 240 may store a GPU driver 220 and compiler, a GPU program, and a locally-compiled GPU program. The GPU driver 220 may represent a computer program or executable code that provides an interface to access GPU 225. CPU 210 may execute the GPU driver 220 or portions thereof to interface with GPU 225 and, for this reason, GPU driver 220 is shown in the example of FIG. 2 within CPU 210. GPU driver 220 may be accessible to programs or other executables executed by CPU 210, including the GPU program stored in system memory 240. Thus, when one of the software applications executing on CPU 210 utilizes graphics processing, CPU 210 may provide graphics commands and graphics data to GPU 225 for rendering to display 245 (e.g., via GPU driver 220).

In some cases, the GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc. In general, an API includes a predetermined, standardized set of commands that are executed by associated hardware. API commands allow a user to instruct hardware components of a GPU 225 to execute commands without user knowledge as to the specifics of the hardware components. In order to process the graphics rendering instructions, CPU 210 may issue one or more rendering commands to GPU 225 (e.g., through GPU driver 220) to cause GPU 225 to perform some or all of the rendering of the graphics data. In some examples, the graphics data to be rendered may include a list of graphics primitives (e.g., points, lines, triangles, quadrilaterals, etc.).

The GPU program stored in system memory 240 may invoke or otherwise include one or more functions provided by GPU driver 220. CPU 210 generally executes the program in which the GPU program is embedded and, upon encountering the GPU program, passes the GPU program to GPU driver 220. CPU 210 executes GPU driver 220 in this context to process the GPU program. That is, for example, GPU driver 220 may process the GPU program by compiling the GPU program into object or machine code executable by GPU 225. This object code may be referred to as a locally-compiled GPU program. In some examples, a compiler associated with GPU driver 220 may operate in real-time or near-real-time to compile the GPU program during the execution of the program in which the GPU program is embedded. For example, the compiler generally represents a unit that reduces HL instructions defined in accordance with a HL programming language to low-level (LL) instructions of a LL programming language. After compilation, these LL instructions are capable of being executed by specific types of processors or other types of hardware, such as FPGAs, ASICs, and the like (including, but not limited to, CPU 210 and GPU 225).

According to examples of aspects described herein, the device 200 may include features for receiving a first image from an external source (e.g., a sensor 150, a camera device), generating a second image based on one or more pixels located at each corner of the first image, and processing, by a trained neural network (e.g., machine learning component 155, machine learning component 250), the second image. The device 200 may process the second image using an edge detection filter (e.g., edge detector 255). The device 200 may determine a split-screen condition associated with the first image based on the processing, and output an indication of the determined split-screen condition (e.g., via display 245).

According to examples of aspects described herein, the device 200 may include features for receiving a first image from an external source (e.g., a sensor 150, a camera device) and determining a difference between one or more pixel values of a first set of portions of the first image and one or more pixel values of a second set of portions of the first image. The device 200 may compare the difference to a threshold and determine a split-screen condition associated with the first image based on the comparing, for example, using an edge detection filter (e.g., edge detector 255). The device 200 may output an indication of the determined split-screen condition (e.g., via display 245).

According to examples of aspects described herein, the device 200 may include features for receiving a first image from an external source (e.g., a sensor 150, a camera device), generating a second image based on one or more pixels located at each corner of the first image, and processing, by a trained neural network (e.g., machine learning component 155, machine learning component 250), the second image. The device 200 may process the second image using an edge detection filter (e.g., edge detector 255). The device 200 may determine a difference between one or more pixel values of a first set of portions of the first image and one or more pixel values of a second set of portions of the first image, and may compare the difference to a threshold. The device 200 may determine a split-screen condition based on the processing of the second image by the trained neural network, the comparison of the difference to the threshold, or both, and may output an indication of the determined split-screen condition (e.g., via display 245).

According to examples of aspects described herein, the device 200 may include features for receiving a first image from an external source (e.g., a sensor 150, a camera device), generating a second image based on one or more pixels located at each corner of the first image, and processing, by a trained neural network (e.g., machine learning component 155, machine learning component 250), the second image. The device 200 may determine a difference between one or more pixel values of a first set of portions of the first image and one or more pixel values of a second set of portions of the first image, may compare the difference to a threshold. The device 200 may process the first image using an edge detection filter (e.g., edge detector 255) based on the processing of the second image by the trained neural network, the comparison of the difference to the threshold, or both. The device 200 may determine the split-screen condition based on the processing using the edge detection filter, and may output an indication of the determined split-screen condition (e.g., via display 245).

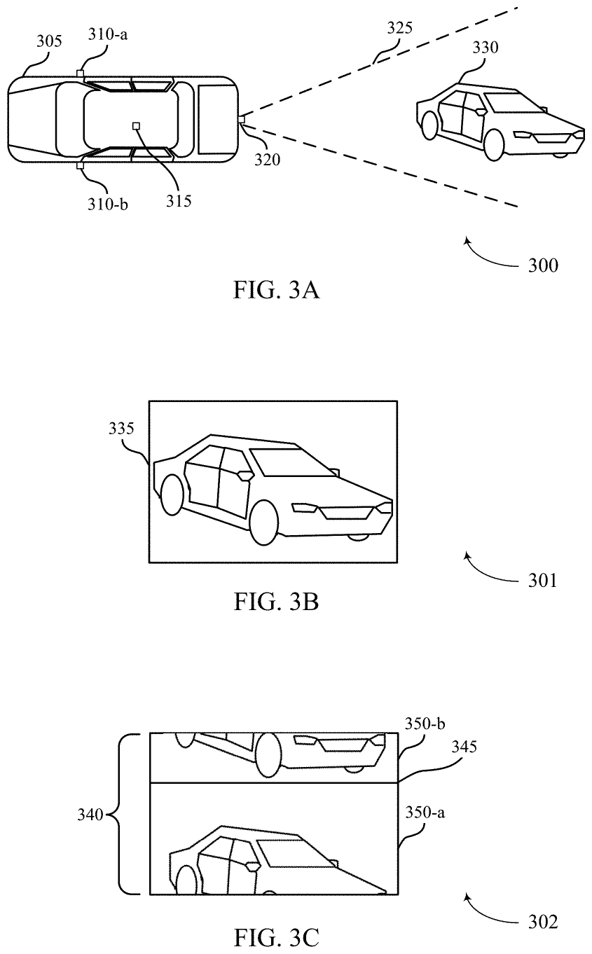

FIGS. 3A through 3C illustrate example split-screen detection diagrams 300 through 302 that support detection of a split-screen condition in accordance with aspects of the present disclosure. In some examples, one or more aspects of split-screen detection diagrams 300 through 302 may be implemented in system 100, may be implemented by devices described herein, etc.

FIG. 3A illustrates an example split-screen detection diagram 300 that supports detection of a split-screen condition in accordance with aspects of the present disclosure. The device 305 may be an example of aspects of devices 105 and 200 as described herein. FIG. 3B illustrates an example split-screen detection diagram 301 that includes an image 335 displayed by the device 305 in accordance with aspects of the present disclosure. FIG. 3C illustrates an example split-screen detection diagram 302 that includes a split image 340 displayed by the device 305 in accordance with aspects of the present disclosure.

In the example illustrated in FIG. 3A, device 305 may be a vehicle (e.g., an automobile) supporting one or more sensors. For example, device 305 may include sensors 310, 315, and 320 equipped to device 305. Sensors 310 (e.g., sensor 310-a, sensor 310-b) may be side view cameras or side mirror cameras, sensor 315 may be an around view camera (e.g., a full circle camera, such as a 360 degree camera, a wide angle camera, such as a 180 degree camera, etc.), and sensor 320 may be a rear view camera. Sensors 310, 315, and 320 may be examples of aspects of sensor 150. In some aspects, one or more of sensors 310, 315, and 320 may transmit images (e.g., still images, video images, video streams) to device 305, via wired or wireless connections (e.g., Wi-Fi, Bluetooth, BLE, cellular, Z-WAVE, 802.11, peer-to-peer, LAN, WLAN, Ethernet, FireWire, fiber optic). Sensors 310, 315, and 320 may be integrated within device 305 or may be components separate from device 305 (e.g., sensors 310, 315, and 320 may be external sources).

Device 305 may display video or images (e.g., via an attached or integrated display) captured by sensors 310, 315, or 320 based on a mode of operation of device 305 or a user input. In some aspects, device 305 may activate or deactivate sensors 310, 315, or 320 based on the mode of operation of device 305 or a user input. In an example, device 305 may display video or images captured (e.g., in real-time) by sensor 310-a based on a user input which selects (e.g., activates) a turn signal. In some examples, device 305 may display video or images captured (e.g., in real-time) by sensor 320 based on a user input which shifts a gear of device 305 to reverse (e.g., from ‘Park’ to ‘Reverse’, from ‘Drive’ to ‘Reverse’). In some aspects, device 305 may display video or images captured (e.g., in real-time) by any or all of sensors 310, 315, and 320 based on a user input (e.g., user selection of one or more of sensors 310, 315, and 320, for example, via a user interface of device 305).

In the example illustrated in FIG. 3, sensor 320 may capture video or images (e.g., in real-time) of an environment or objects to the rear of device 305. For example, sensor 320 may capture video or images of an environment or objects (e.g., vehicle) within a field of view 325 of sensor 320. In some aspects, device 305 may display video or images captured (e.g., in real-time) by a source separate from device 305 (e.g., a sensor or camera not equipped or coupled to device 305). In some aspects, the source may transmit images (e.g., still images, video images, video streams) to the device 305, via wired or wireless connections as described herein. In an example, device 305 may receive and display video or images of an area including or within a proximity to device 305 (e.g., surveillance cameras, security cameras, CCTV (closed-circuit television) cameras).

FIGS. 3B and 3C illustrates example split-screen detection diagrams 301 and 302 that support detection of a split-screen condition in accordance with aspects of the present disclosure. In the example illustrated in FIG. 3B, image 335 is a correctly displayed image (e.g., such that a split-screen condition is not present for an image 335 displayed by device 305). In the example illustrated in FIG. 3C, image 340 is an example of a split image (e.g., such that a split-screen condition is present for an image 340 displayed by device 305). As illustrated in the example of FIG. 3C, a split 345 is present in image 340 due to a split-screen condition, which results in disoriented or split example portions 350-a and 350-b. In some aspects, split 345 present between portions 350-b and 350-a may be associated with an edge of a correctly displayed image (e.g., split 345 may correspond to an upper edge or lower edge of image 335).

According to examples of aspects described herein, device 305 may indicate the occurrence of the split-screen condition to a user or device 200 may output a location of the split-screen condition to a user. For example, device 305 may display an indication of the split-screen condition on a display device (e.g., a monitor) on which device 305 is displaying image 340. In some examples, device 305 may display an indication of the split-screen condition on a different display device (e.g., vehicle heads up display (HUD)) equipped to device 305. In an example, device 305 may display a colored line (e.g., a green line, a blue line, a red line) or a bounding box at a location of image 340 corresponding to split 345. In some aspects, to alert the user of the split-screen condition, device 305 may activate an LED warning indicator equipped to device 305 or output an audible alert via one or more speakers equipped to device 305.

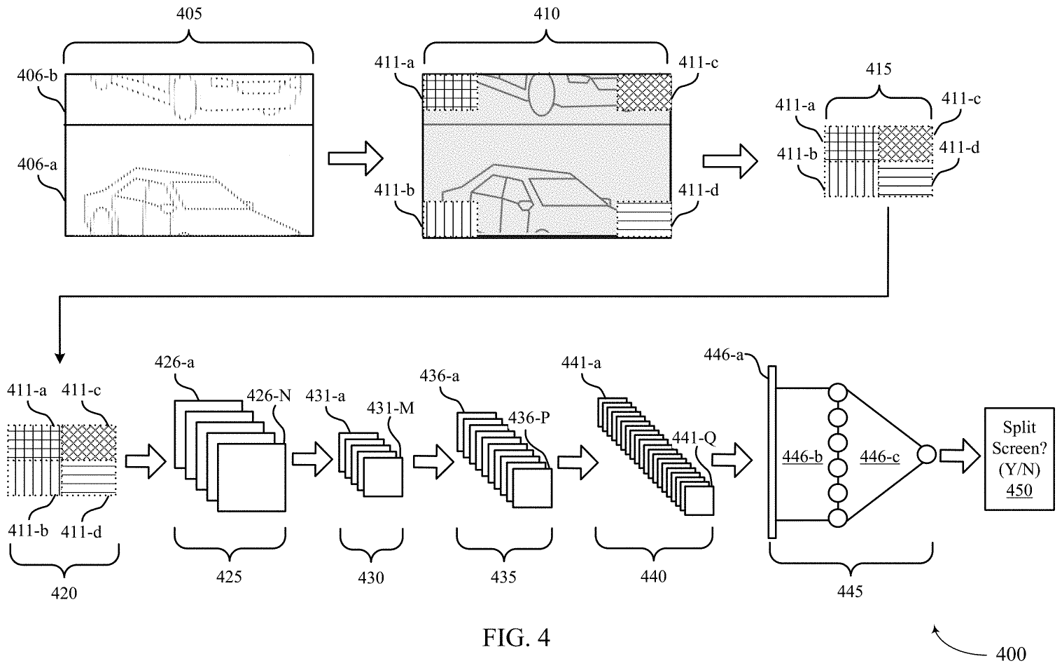

FIG. 4 illustrates an example image processing diagram 400 for detecting a split-screen condition in accordance with aspects of the present disclosure. In some cases, aspects of image processing diagram 400 may be implemented in system 100, may be implemented by devices described herein, etc. For example, aspects of image processing diagram 400 may be performed by any of devices 105, 200, and 305 as described herein.

Device 105 may detect a split-screen condition using one or more stages as described herein. In the example of FIG. 4, device 105 may implement operations 405 through 415 as part of a first stage (e.g., generating a second image, for example, by image truncation or image sampling). In an example, device 105 may implement operations 420 through 450 as part of a second stage (e.g., processing of the second image by a machine learning network).

At 405, device 105 may receive one or more packets (e.g., data packets corresponding to one or more video frames) from an external source (e.g., a sensor 150). For example, device 105 may receive a first image (e.g., data packets) from the external source.

In the example of FIG. 4, the received image may be a split image (e.g., a split-screen condition is present in the image as displayed by a device 105), and the device 105 may display disoriented or misaligned portions 406-a and 406-b due to the split-screen condition.

At 410, device 105 may identify or select a subset of pixels of the image generated at 405. In some examples, the subset may include pixels or pixel arrays (as shown by 411-a through 411-d) located at four corners of the image. In an example, the subset may include one or more, for example, two pixels or two pixel arrays (e.g., 411-a and 411-d). Generally, device 105 may identify or select a subset of pixels or pixel arrays from any location of the image (e.g., a center pixel location, a random pixel location, a pixel location based on weights associated with pixels, pixels located in one or more rows at the top or bottom of the image, pixels located in one or more columns at the left or right edge of the image).

At 415, device 105 may generate a second image based on the subset of pixels or pixel arrays (e.g., identified or selected at 410). For example, device 105 may copy or extract the subset of pixels or pixel arrays and generate the second image. In some aspects, the second image may include one or multiple pixels or pixel arrays of the image received at 405. In some aspects, the second image may include four quadrants, and each of the quadrants (as shown by 411-a through 411-d) may include an array of one or more pixels from a respective corner of the first image (e.g., when the device 105 selects one or more pixels, at 410, from each corner of the image generated at 405). In some aspects, the second image may be a truncated or smaller image compared to the received image.

At 420, device 105 may initiate processing of the second image by a machine learning component (e.g., device 105 may input the second image into a machine learning component). The machine learning component may be an example of aspects of the machine learning component 155 or machine learning component 250 as described herein. The machine learning component may include or refer to a machine learning network (e.g., a neural network, a deep neural network, a convolutional neural network, a trained neural network). In some aspects, the machine learning network may include one or more intermediate layers (e.g., one or more intermediate hidden layers). For example, the machine learning network may include convolutional layers (e.g., layers of convolution filters, neural network layers), followed by pooling layers (e.g., a maximum pooling layer) and a layer of perceptrons (e.g., a fully connected layer of perceptrons). In some examples, the machine learning component may include one or more layers (e.g., neural network layers, convolution layers). Each of the layers of the machine learning component may include one or more nodes (e.g., one or more neurons) arranged therein and may provide one or more activation functions.

At 425, device 105 may process an input image (e.g., the second image), for example, utilizing one or more of convolutional layers 426-a through 426-N. In the example of FIG. 4, N may be an integer of 5. In some aspects, device 105 may extract image data (e.g., image features) present in the input image (e.g., the second image) using convolutional layers 426-a through 426-N. For example, convolutional layers 426-a through 426-N may include respectively different edge detection filters, and device 105 may utilize one or more of the edge detection filters to extract features present in the input image (e.g., the second image). In processing the input image (e.g., the second image), convolutional layers 426-a through 426-N may extract and output image data based on the edge detection filters. In an example, convolutional layers 426-a through 426-N may output one or more feature maps.

At 430, device 105 may process the image data (e.g., feature maps) output by convolutional layers 426-a through 426-N, for example, utilizing one or more pooling layers 431-a through 431-M. In the example of FIG. 4, M may be an integer of 5. In some aspects, pooling layers 431-a through 431-M may downsample the image data (e.g., feature maps) extracted by convolutional layers 426-a through 426-N to progressively reduce the dimensionality (e.g., spatial size) of the image data, which may decrease processing time. In some aspects, device 105 may use a maximum pooling algorithm, and pooling layers 431-a through 431-M may be, for example, maximum pooling layers which may extract subregions of the feature maps (e.g., 2×2-pixel tiles), maintain maximum values of the feature maps, and discard all other values. In some aspects, device 105 may maintain one or more representative features from the image data (e.g., feature maps) which device 105 may use for detecting a split-screen condition.

In some aspects, via convolutional layers 426 and pooling layers 431, device 105 may extract low-level features (e.g., lines) in an input image (e.g., the second image). In some aspects, via convolutional layers 426 and pooling layers 431 as described herein, device 105 may extract high-level features (e.g., shapes, specific objects) of the input image (e.g., the second image).

At 435, device 105 may process the output of pooling layers 431-a through 431-M, for example, utilizing one or more of convolutional layers 436-a through 436-P. In the example of FIG. 4, P may be an integer of 10. Aspects of convolutional layers 436-a through 436-P may be similar to those of convolutional layers 426-a through 426-N as described herein.

At 440, device 105 may process the output of convolutional layers 436-a through 436-P, for example, utilizing one or more pooling layers 441-a through 441-Q. Pooling layers 441-a through 441-Q may be, for example, maximum pooling layers. In the example of FIG. 4, Q may be an integer of 20. Aspects of pooling layers 441-a through 441-Q may be similar to those of pooling layers 431-a through 431-M as described herein.

At 445, device 105 may flatten (e.g., at 446-a) the output by pooling layers 441-a through 441-Q (e.g., device 105 may flatten a pooled feature map output by pooling layers 441-a through 441-Q). Using dense (e.g., fully connected) layers 446-b and 446-c, device 105 may classify the features extracted by the convolutional layers (e.g., convolutional layers 426-a through 426-N, convolutional layers 436-a through 436-P) and downsampled by the pooling layers (e.g., pooling layers 431-a through 431-M, pooling layers 441-a through 441-Q).

At 450, device 105 may determine whether a split-screen condition has occurred. For example, device 105 may utilize the features as classified and downsampled by the machine learning component to accurately detect split-screen images. In some aspects, the machine learning component (e.g., a learning model within the machine learning component) may be incorporated with machine learning dedicated hardware or neural processing engines (e.g., Snapdragon Neural Processing Engine (SNPE)). The example of FIG. 4 is described for illustrative purposes, and is not intended to be limit the scope of the techniques described herein. For example, various other machine learning networks may be implemented by analogy (e.g., 425 through 445 may be implemented in a different order, some operations may be removed from 425 through 445, or additional operations may be added to 425 through 445), without departing from the scope of the present disclosure.

In some aspects, device 105 may output an indication of the determined split-screen condition (e.g., via display 245). For example, device 105 may output a confirmation of the split-screen condition. In some aspects, device 105 may request (e.g., and receive) a retransmission of the first image from the external source (e.g., sensor 150) based on the output indication of the determined split-screen condition.

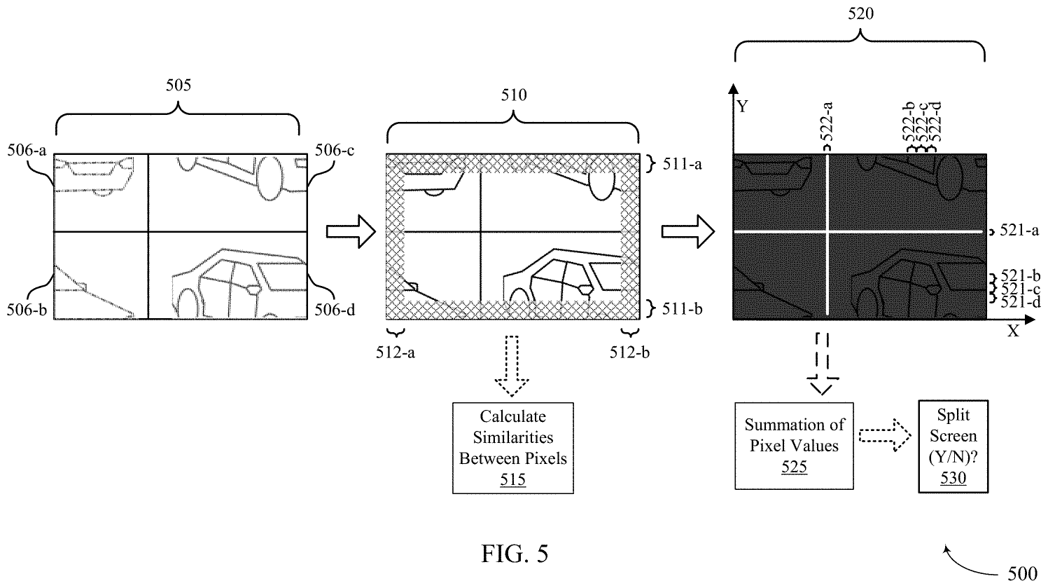

FIG. 5 illustrates an example image processing diagram 500 that supports detection of a split-screen condition in accordance with aspects of the present disclosure. In some examples, aspects of image processing diagram 500 may be implemented in system 100, may be implemented by devices described herein, etc. For example, aspects of image processing diagram 500 may be performed by any of devices 105, 200, and 305 as described herein.

According to examples of aspects described herein, device 105 may detect a split-screen condition using one or more stages as described herein. In the example of FIG. 5, device 105 may implement operations 505 through 515 as part of a first stage (e.g., determining a difference between one or more pixel values of a first set of portions of a first image and one or more pixel values of a second set of portions of the first image, comparing the difference to a threshold). In an example, device 105 may implement operations 520 through 530 as part of a second stage (e.g., determining a split-screen condition associated with the first image based on the comparing).

At 505, device 105 may receive an image (e.g., a first image) from an external source (e.g., a sensor 150). In the example of FIG. 5, the received image may be a split image (e.g., a split-screen condition may be present in the image as displayed by device 105), and the device 105 may display disoriented or misaligned portions 506-a through 506-d due to the split-screen condition.

At 510, device 105 may identify or select a first set of portions of the first image and a second set of portions of the first image. In an example, the first and second sets of portions of the first image may include rows of the first image (e.g., rows of pixels of the first image). For example, the first set of portions of the first image may include one or more top rows 511-a of the first image (e.g., a top row of pixels of the first image), and the second set of portions of the first image may include one or more bottom rows 511-b of the first image (e.g., a bottom row of pixels of the first image). In some aspects, the first and second sets of portions of the first image may include columns of the first image (e.g., columns of pixels of the first image). For example, the first set of portions of the first image may include one or more leftmost columns 512-a of the first image (e.g., a leftmost column of pixels of the first image), and the second set of portions of the first image may include one or more rightmost columns 512-b of the first image (e.g., a rightmost column of pixels of the first image).

At 515, device 105 may determine an occurrence of a split-screen condition (e.g., split-screen condition present, split-screen condition not present) and a type of split-screen condition associated with the occurrence (e.g., vertical, horizontal, or both). For example, device 105 may determine whether a difference between one or more pixel values of the first set of portions of the first image and one or more pixel values of the second set of portions of the first image satisfies a threshold.

For example, at 515, in determining the difference between one or more pixel values of the first set of portions of the first image and one or more pixel values of the second set of portions of the first image, device 105 may determine a sum of differences squared between the one or more pixel values of the first set of portions of the first image and the one or more pixel values of the second set of portions of the first image. In an example, device 105 may normalize the determined sum of differences squared based on a dimension size of the first image. In some examples, device 105 may perform one or more convolution calculations based on the normalized sum.

In an example, at 515, device 105 may determine a difference between one or more pixel values of a first set of one or more rows of the first image and one or more pixel values of a second set of one or more rows of the first image. In some aspects, device 105 may determine a difference between pixel values of top row 511-a of the first image and pixel values of bottom row 511-b of the first image. Based on the difference between pixel values of the rows (e.g., the difference satisfies a threshold, for example, is below a threshold), device 105 may determine the split-screen condition includes a horizontal split-screen condition. For example, when comparing pixel values of top row 511-a and bottom row 511-b, if device 105 determines the pixel values are equal (e.g., difference between pixel values is within a threshold), device 105 may determine that the split-screen condition includes a horizontal split-screen condition.

In some examples, at 515, device 105 may determine a difference between one or more pixel values of a first set of one or more columns of the first image and one or more pixel values of a second set of one or more columns of the first image. In some aspects, device 105 may determine a difference between pixel values of leftmost column 512-a of the first image and pixel values of rightmost column 512-b of the first image. Based on the difference between pixel values of the columns (e.g., the difference satisfies a threshold, for example, is below a threshold), device 105 may determine the split-screen condition includes a vertical split-screen condition. For example, when comparing pixel values of leftmost column 512-a and rightmost column 512-b, if device 105 determines the pixel values are equal (e.g., difference between pixel values is within a threshold), device 105 may determine that the split-screen condition includes a vertical split-screen condition.

In some aspects, device 105 may perform additional analysis on the first image. For example, at 520, device 105 may process the first image using an edge detection filter (e.g., edge detector 255). In some aspects, device 105 may process the first image using an edge detection filter based on determining (e.g., at 515) that a split-screen condition exists (e.g., vertical, horizontal, or both). In an example, using the edge detection filter, device 105 may convert all edges present in the first image (e.g., edge pixels of the first image) into white pixels (e.g., set the pixel values to white, for example, by setting an RGB pixel value of (255, 255, 255)), while removing color values from the remainder of the first image (e.g., pixels other than the edge pixels). For example, device 105 may convert the remainder of the first image (e.g., pixels other than the edge pixels) into black pixels (e.g., set the pixel values to black, for example, to an RGB pixel value of 0, 0, 0). In some aspects, device 105 may convert all the edges present in the first image into both gray and white pixels (e.g., based on edge strength associated with the edges) For example, device 105 may output a bitmap file indicating the edge strengths, using a matrix of 8-bit gray values.

At 525, device 105 may check for white pixels (e.g., identify pixel values indicative of white pixels) in the converted image, row by row, or column by column, based on the type of split-screen determined at 515. For example, for a vertical split-screen condition determined at 515, device 105 may check the converted image for white pixels, row by row. In some aspects, device 105 may determine a pixel location of each white pixel and append the pixel locations to an array (e.g., an array of the y-coordinate) of the converted image. Device 105 may calculate a summation of pixel values (e.g., corresponding to the pixel locations) and compare the summation to a threshold. In an example, device 105 may determine (e.g., confirm) the split-screen condition based on whether the summation satisfies the threshold (e.g., is greater than the threshold).

In an example, for a horizontal split-screen condition determined at 515, device 105 may check pixel values of white pixels, column by column. In some aspects, device 105 may determine a pixel location of each white pixel and append the pixel locations to an array (e.g., an array of the x-coordinate) of the converted image. Device 105 may calculate a summation of pixel values (e.g., corresponding to the pixel locations) and compare the summation to a threshold. In an example, device 105 may determine (e.g., confirm) the split-screen condition based on whether the summation satisfies the threshold (e.g., is greater than the threshold).

Accordingly, in some aspects, at 520, device 105 may convert pixels of one or more rows (e.g., rows 521-b through 521-d) of the first image into white pixels (e.g., using an edge detection filter). In an example, at 525, device 105 may append the white pixels to one or more pixel arrays (e.g., an array of the y-coordinate) and compare the one or more pixel arrays to a threshold. In some aspects, at 530, device 105 may determine a split-screen condition (e.g., a vertical split-screen condition) based on the comparison.

In some aspects, at 520, device 105 may convert pixels of one or more columns (e.g., columns 522-b through 522-d) of the first image into white pixels (e.g., using an edge detection filter). In an example, at 525, device 105 may append the white pixels to one or more pixel arrays (e.g., an array of the x-coordinate) and compare the one or more pixel arrays to a threshold. In some aspects, at 530, device 105 may determine a split-screen condition (e.g., a horizontal split-screen condition) based on the comparison.

In some aspects, at 530, device 105 may determine both a vertical split-screen condition and a horizontal split-screen condition exist, based on the comparisons at 525.

At 535, device 105 may output an indication of the determined split-screen condition (e.g., via display 245). For example, device 105 may output a confirmation of the split-screen condition. In some aspects, device 105 may request (e.g., and receive) a retransmission of the first image from the external source (e.g., sensor 150) based on the output indication of the determined split-screen condition.

Aspects of the examples as described herein may be incorporated with modified (e.g., faster, higher accuracy) split-screen detection techniques. In some aspects, device 105 may incorporate test data (e.g., real or artificial training images) along with neural networks and machine learning to achieve accurate tunable values.

In some examples, aspects of FIG. 4 and FIG. 5 may be combined or interchanged. For example, device 105 may incorporate or interchange the operations 405 through 450 (e.g., image truncation and processing of the truncated image by a machine learning network), the operations 505 through 515 (e.g., determination of a split-screen condition based on a difference in pixel values of different portions of an image), or the operations 520 through 530 (e.g., edge detection filter, determination of a split-screen condition based on a summation of pixel values of white pixels). In some aspects, device 105 may verify the machine learning component (e.g., trained neural network) based on the processing using the edge detection filter.

In some aspects, for example, where device 105 is a vehicle (e.g., device 305), device 105 may be configured to determine (e.g., confirm) all split-screen conditions associated with an image captured by sensor 320 (e.g., where sensor 320 is a rear-view or backup camera). For example, device 105 may be configured to confirm all split-screen conditions, using any of operations 405 through 450, operations 505 through 515, or operations 520 through 530.

In some aspects, device 105 may determine whether to confirm a split-screen condition based on one or more criteria (e.g., such as power consumption considerations, power capacity considerations, accuracy considerations or based on how critical accurate split-screen detection is in a given application, based on other limitations of the device 105, etc.). For example, device 105 may determine (e.g., confirm) a split-screen condition based on a power consumption threshold of device 105. In some examples, device 105 may determine (e.g., confirm) a split-screen condition based on the split-screen condition having a severity level above a severity threshold. In an example, device 105 may determine (e.g., confirm) a split-screen condition based on a frequency threshold associated with the split-screen condition (e.g., based on a number of times device 105 detects a split-screen condition within a set duration).

According to examples of aspects described herein, the device 105 may include features for receiving a first image from an external source (e.g., a sensor 150, a camera device), generating a second image based on one or more pixels located at each corner of the first image, and processing, by a trained neural network (e.g., machine learning component 155, machine learning component 250), the second image. The device 105 may process the second image using an edge detection filter (e.g., edge detector 255). The device 105 may determine a difference between one or more pixel values of a first set of portions (e.g., a top row 511-a, or a leftmost column 512-a) of the first image and one or more pixel values of a second set of portions (e.g., a bottom row 511-b, or a rightmost column 512-b) of the first image, and may compare the difference to a threshold. The device 105 may determine a split-screen condition based on the processing of the second image by the trained neural network, the comparison of the difference to the threshold, or both, and may output an indication of the determined split-screen condition (e.g., via display 245).

According to examples of aspects described herein, the device 105 may include features for receiving a first image from an external source (e.g., a sensor 150, a camera device), generating a second image based on one or more pixels located at each corner of the first image, and processing, by a trained neural network (e.g., machine learning component 155, machine learning component 250), the second image. The device 105 may determine a difference between one or more pixel values of a first set of portions (e.g., a top row 511-a, or a leftmost column 512-a) of the first image and one or more pixel values of a second set of portions (e.g., a bottom row 511-b, or a rightmost column 512-b) of the first image, may compare the difference to a threshold. The device 105 may process the first image using an edge detection filter (e.g., edge detector 255) based on the processing of the second image by the trained neural network, the comparison of the difference to the threshold, or both. The device 105 may determine the split-screen condition based on the processing using the edge detection filter, and may output an indication of the determined split-screen condition (e.g., via display 245).

FIG. 6 shows a block diagram 600 of a device 605 that supports detection of a split-screen condition in accordance with aspects of the present disclosure. The device 605 may be an example of aspects of a device as described herein. The device 605 may include a CPU 610, a display manager 615, and a display 620. The device 605 may also include a processor. Each of these components may be in communication with one another (e.g., via one or more buses).

CPU 610 may be an example of CPU 210 described with reference to FIG. 2. CPU 610 may execute one or more software applications, such as web browsers, graphical user interfaces, video games, or other applications involving graphics rendering for image depiction (e.g., via display 620). As described herein, CPU 610 may encounter a GPU program (e.g., a program suited for handling by display manager 615) when executing the one or more software applications. Accordingly, CPU 610 may submit rendering commands to display manager 615 (e.g., via a GPU driver containing a compiler for parsing API-based commands). For example, CPU 610 may submit commands to display manager 615 related to detection of a split-screen condition.

The display manager 615 may receive a first image from an external source, generate a second image based on one or more pixels located at each corner of the first image, process, by a trained neural network, the second image, determine a split-screen condition associated with the first image based on the processing, and output an indication of the determined split-screen condition. The display manager 615 may also receive a first image from an external source, determine a difference between one or more pixel values of a first set of portions of the first image and one or more pixel values of a second set of portions of the first image, compare the difference to a threshold, determine a split-screen condition associated with the first image based on the comparing, and output an indication of the determined split-screen condition. The display manager 615 may be an example of aspects of the display manager 910 described herein. In some cases, display manager 615 may be an example of aspects of a GPU 225 described herein.

The display manager 615, or its sub-components, may be implemented in hardware, code (e.g., software or firmware) executed by a processor, or any combination thereof. If implemented in code executed by a processor, the functions of the display manager 615, or its sub-components may be executed by a general-purpose processor, a DSP, an ASIC, a FPGA or other programmable logic device, discrete gate or transistor logic, discrete hardware components, or any combination thereof designed to perform the functions described in the present disclosure.

The display manager 615, or its sub-components, may be physically located at various positions, including being distributed such that portions of functions are implemented at different physical locations by one or more physical components. In some examples, the display manager 615, or its sub-components, may be a separate and distinct component in accordance with various aspects of the present disclosure. In some examples, the display manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Display 620 may display content generated by other components of the device. Display 620 may be an example of display 245 as described with reference to FIG. 2. In some examples, display 620 may be connected with a display buffer which stores rendered data until an image is ready to be displayed (e.g., as described with reference to FIG. 2). In some cases, the split-screen condition may be associated with display 620. In some cases, display 620 may (e.g., upon display manager 615 detection of a split-screen condition) output an indication of the determined split-screen condition (e.g., to a user of the device viewing the display 620).

FIG. 7 shows a block diagram 700 of a device 705 that supports detection of a split-screen condition in accordance with aspects of the present disclosure. The device 705 may be an example of aspects of a device 605 or a device 105 as described herein. The device 705 may include a CPU 710, a display manager 715, and a display 740. The device 705 may also include a processor. Each of these components may be in communication with one another (e.g., via one or more buses).

CPU 710 may be an example of CPU 210 described with reference to FIG. 2. CPU 710 may execute one or more software applications, such as web browsers, graphical user interfaces, video games, or other applications involving graphics rendering for image depiction (e.g., via display 740). As described herein, CPU 710 may encounter a GPU program (e.g., a program suited for handling by display manager 715) when executing the one or more software applications. Accordingly, CPU 710 may submit rendering commands to display manager 715 (e.g., via a GPU driver containing a compiler for parsing API-based commands). For example, CPU 710 may submit commands to display manager 715 related to detection of a split-screen condition.

The display manager 715 may be an example of aspects of the display manager 615 as described herein. The display manager 715 may include an external image manager 720, a neural network manager 725, a split-screen manager 730, and a pixel difference manager 735. The display manager 715 may be an example of aspects of the display manager 910 described herein.

The external image manager 720 may receive a first image from an external source and generate a second image based on one or more pixels located at each corner of the first image. The neural network manager 725 may process, by a trained neural network, the second image. The split-screen manager 730 may determine a split-screen condition associated with the first image based on the processing and output an indication of the determined split-screen condition. The external image manager 720 may receive a first image from an external source.

The pixel difference manager 735 may determine a difference between one or more pixel values of a first set of portions of the first image and one or more pixel values of a second set of portions of the first image and compare the difference to a threshold. The split-screen manager 730 may determine a split-screen condition associated with the first image based on the comparing and output an indication of the determined split-screen condition.

Display 740 may display content generated by other components of the device. Display 740 may be an example of display 245 as described with reference to FIG. 2. In some examples, display 740 may be connected with a display buffer which stores rendered data until an image is ready to be displayed (e.g., as described with reference to FIG. 2).

FIG. 8 shows a block diagram 800 of a display manager 805 that supports detection of a split-screen condition in accordance with aspects of the present disclosure. The display manager 805 may be an example of aspects of a display manager 615, a display manager 715, or a display manager 910 described herein. The display manager 805 may include an external image manager 810, a neural network manager 815, a split-screen manager 820, an edge detection manager 825, and a pixel difference manager 830. Each of these modules may communicate, directly or indirectly, with one another (e.g., via one or more buses).

The external image manager 810 may receive a first image from an external source. In some examples, the external image manager 810 may generate a second image based on one or more pixels located at each corner of the first image. In some examples, the external image manager 810 may receive a first image from an external source. In some examples, the external image manager 810 may receive one or more images from the external source.

In some examples, the external image manager 810 may receive a retransmission of the first image from the external source based on the output indication of the determined split-screen condition, where the indication of the determined split-screen condition is output to the external source. In some examples, the external image manager 810 may receive a retransmission of the first image from the external source based on the output indication of the determined split-screen condition. In some cases, the second image includes four quadrants, and each of the quadrants includes an array of one or more pixels from a respective corner of the first image.

The neural network manager 815 may process, by a trained neural network, the second image. In some examples, the neural network manager 815 may verify the trained neural network based on the processing the using the edge detection filter. In some examples, the neural network manager 815 may train the trained neural network based on the received one or more images.

The split-screen manager 820 may determine a split-screen condition associated with the first image based on the processing. In some examples, the split-screen manager 820 may output an indication of the determined split-screen condition. In some examples, the split-screen manager 820 may determine a split-screen condition associated with the first image based on the comparing. In some examples, the split-screen manager 820 may output an indication of the determined split-screen condition. In some examples, the split-screen manager 820 may determine a vertical split-screen condition based on the comparison, where the output indication is indicative of the vertical split-screen condition. In some examples, the split-screen manager 820 may determine a horizontal split-screen condition based on the comparison, where the output indication is indicative of the horizontal split-screen condition.

In some examples, the split-screen manager 820 may determine a horizontal split-screen condition associated with the first image, determine a vertical split-screen condition associated with the first image, or both. In some examples, the split-screen manager 820 may determine a horizontal split-screen condition associated with the first image, a vertical split-screen condition associated with the first image, or both, where the output indication is indicative of the horizontal split-screen condition, the vertical split-screen condition, or both.

In some cases, the split-screen condition is determined based on a power consumption threshold of the device, a frequency threshold associated with the split-screen condition determination, a severity threshold associated with the split-screen condition determination, or some combination thereof.

The pixel difference manager 830 may determine a difference between one or more pixel values of a first set of portions of the first image and one or more pixel values of a second set of portions of the first image. In some examples, the pixel difference manager 830 may compare the difference to a threshold. In some examples, the pixel difference manager 830 may determine a sum of differences squared between the one or more pixel values of the first set of portions of the first image and the one or more pixel values of the second set of portions of the first image. In some examples, the pixel difference manager 830 may normalize the determined sum of differences squared based on a dimension size of the first image. In some examples, the pixel difference manager 830 may perform one or more convolution calculations based on at least in part on the normalized sum.

In some examples, the pixel difference manager 830 may determine a difference between one or more pixel values of a first set of one or more rows of the first image and one or more pixel values of a second set of one or more rows of the first image, where the determined split-screen condition includes a horizontal split-screen condition. In some examples, the pixel difference manager 830 may determine a difference between one or more pixel values of a first set of one or more columns of the first image and one or more pixel values of a second set of one or more columns of the first image, where the determined split-screen condition includes a vertical split-screen condition.

The edge detection manager 825 may process the first image using an edge detection filter, where the split-screen condition is determined based on the processing using the edge detection filter. In some examples, the edge detection manager 825 may convert pixels of one or more rows of the first image into white pixels. In some examples, the edge detection manager 825 may append the white pixels to one or more pixel arrays. In some examples, the edge detection manager 825 may compare the one or more pixel arrays to a threshold, where the split-screen condition is determined based on the comparison. In some examples, the edge detection manager 825 may convert pixels of one or more columns of the first image into white pixels. In some examples, the edge detection manager 825 may perform an edge detection operation on one or more columns of pixels of the first image, perform an edge detection operation one or more rows of pixels of the first image, or both, based on the determined the split-screen condition. In some examples, the edge detection manager 825 may process the first image using an edge detection filter, where the split-screen condition is determined based on the processing using the edge detection filter.

FIG. 9 shows a diagram of a system 900 including a device 905 that supports detection of a split-screen condition in accordance with aspects of the present disclosure. The device 905 may be an example of or include the components of device 605, device 705, or a device as described herein. The device 905 may include components for bi-directional voice and data communications including components for transmitting and receiving communications, including a display manager 910, an I/O controller 915, a transceiver 920, an antenna 925, memory 930, and a processor 940. These components may be in electronic communication via one or more buses (e.g., bus 945).

The display manager 910 may receive a first image from an external source, generate a second image based on one or more pixels located at each corner of the first image, process, by a trained neural network, the second image, determine a split-screen condition associated with the first image based on the processing, and output an indication of the determined split-screen condition. The display manager 910 may also receive a first image from an external source, determine a difference between one or more pixel values of a first set of portions of the first image and one or more pixel values of a second set of portions of the first image, compare the difference to a threshold, determine a split-screen condition associated with the first image based on the comparing, and output an indication of the determined split-screen condition.

The I/O controller 915 may manage input and output signals for the device 905. The I/O controller 915 may also manage peripherals not integrated into the device 905. For example, in some cases, the I/O controller 915 may manage data packets corresponding to image information received from an external source. In some cases, the I/O controller 915 may represent a physical connection or port to an external peripheral. In some cases, the I/O controller 915 may utilize an operating system such as iOS®, ANDROID®, MS-DOS®, MS-WINDOWS®, OS/2®, UNIX®, LINUX®, or another known operating system. In other cases, the I/O controller 915 may represent or interact with a modem, a keyboard, a mouse, a touchscreen, or a similar device. In some cases, the I/O controller 915 may be implemented as part of a processor. In some cases, a user may interact with the device 905 via the I/O controller 915 or via hardware components controlled by the I/O controller 915.

The transceiver 920 may communicate bi-directionally, via one or more antennas, wired, or wireless links as described herein. For example, the transceiver 920 may represent a wireless transceiver and may communicate bi-directionally with another wireless transceiver. For example, in some cases, the transceiver 920 may wirelessly receive data packets corresponding to image information received from an external source. The transceiver 920 may also include a modem to modulate the packets and provide the modulated packets to the antennas for transmission, and to demodulate packets received from the antennas.

In some cases, the wireless device may include a single antenna 925. However, in some cases the device may have more than one antenna 925, which may be capable of concurrently transmitting or receiving multiple wireless transmissions.

The memory 930 may include RAM and ROM. The memory 930 may store computer-readable, computer-executable code or software 935 including instructions that, when executed, cause the processor to perform various functions described herein. In some cases, the memory 930 may contain, among other things, a BIOS which may control basic hardware or software operation such as the interaction with peripheral components or devices.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into the processor 940. The processor 940 may be configured to execute computer-readable instructions stored in a memory (e.g., the memory 930) to cause the device 905 to perform various functions (e.g., functions or tasks supporting detection of a split-screen condition).

The software 935 may include instructions to implement aspects of the present disclosure, including instructions to support image processing. The software 935 may be stored in a non-transitory computer-readable medium such as system memory or other type of memory. In some cases, the software 935 may not be directly executable by the processor 940 but may cause a computer (e.g., when compiled and executed) to perform functions described herein.

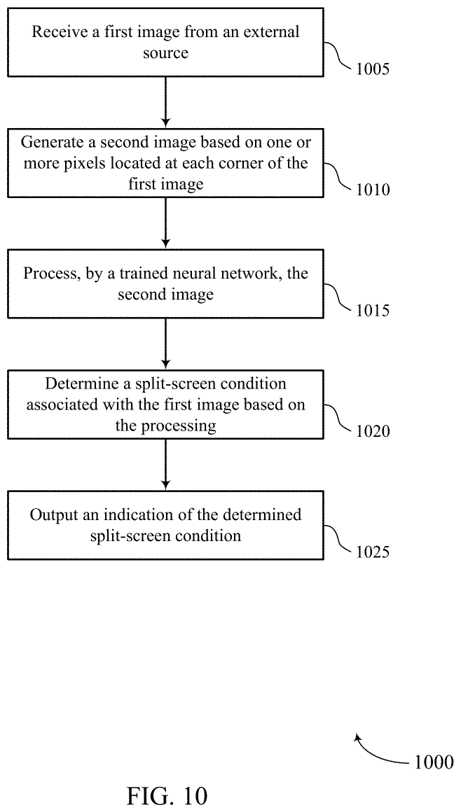

FIG. 10 shows a flowchart illustrating a method 1000 that supports detection of a split-screen condition in accordance with aspects of the present disclosure. The operations of method 1000 may be implemented by a device or its components as described herein. For example, the operations of method 1000 may be performed by a display manager as described with reference to FIGS. 6 through 9. In some examples, a device may execute a set of instructions to control the functional elements of the device to perform the functions described herein. Additionally or alternatively, a device may perform aspects of the functions described herein using special-purpose hardware.

At 1005, the device may receive a first image from an external source. The operations of 1005 may be performed according to the methods described herein. In some examples, aspects of the operations of 1005 may be performed by an external image manager as described with reference to FIGS. 6 through 9.

At 1010, the device may generate a second image based on one or more pixels located at each corner of the first image. The operations of 1010 may be performed according to the methods described herein. In some examples, aspects of the operations of 1010 may be performed by an external image manager as described with reference to FIGS. 6 through 9.

At 1015, the device may process, by a trained neural network, the second image. The operations of 1015 may be performed according to the methods described herein. In some examples, aspects of the operations of 1015 may be performed by a neural network manager as described with reference to FIGS. 6 through 9.

At 1020, the device may determine a split-screen condition associated with the first image based on the processing. The operations of 1020 may be performed according to the methods described herein. In some examples, aspects of the operations of 1020 may be performed by a split-screen manager as described with reference to FIGS. 6 through 9.

At 1025, the device may output an indication of the determined split-screen condition. The operations of 1025 may be performed according to the methods described herein. In some examples, aspects of the operations of 1025 may be performed by a split-screen manager as described with reference to FIGS. 6 through 9.

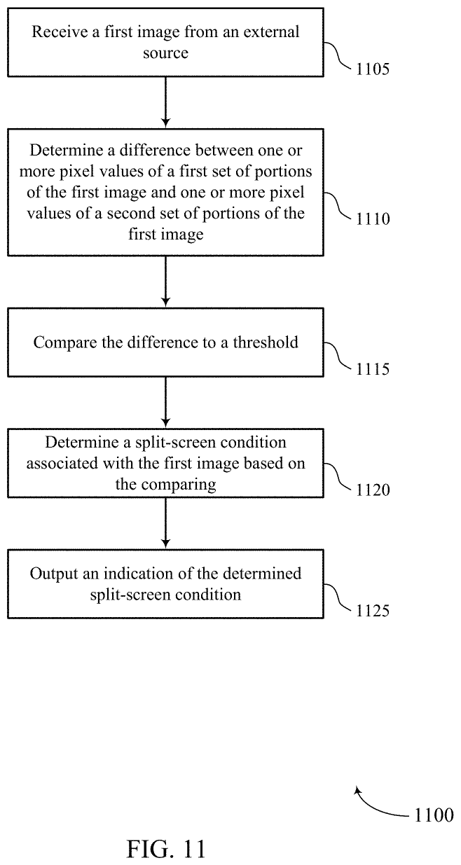

FIG. 11 shows a flowchart illustrating a method 1100 that supports detection of a split-screen condition in accordance with aspects of the present disclosure. The operations of method 1100 may be implemented by a device or its components as described herein. For example, the operations of method 1100 may be performed by a display manager as described with reference to FIGS. 6 through 9. In some examples, a device may execute a set of instructions to control the functional elements of the device to perform the functions described herein. Additionally or alternatively, a device may perform aspects of the functions described herein using special-purpose hardware.

At 1105, the device may receive a first image from an external source. The operations of 1105 may be performed according to the methods described herein. In some examples, aspects of the operations of 1105 may be performed by an external image manager as described with reference to FIGS. 6 through 9.

At 1110, the device may determine a difference between one or more pixel values of a first set of portions of the first image and one or more pixel values of a second set of portions of the first image. The operations of 1110 may be performed according to the methods described herein. In some examples, aspects of the operations of 1110 may be performed by a pixel difference manager as described with reference to FIGS. 6 through 9.

At 1115, the device may compare the difference to a threshold. The operations of 1115 may be performed according to the methods described herein. In some examples, aspects of the operations of 1115 may be performed by a pixel difference manager as described with reference to FIGS. 6 through 9.

At 1120, the device may determine a split-screen condition associated with the first image based on the comparing. The operations of 1120 may be performed according to the methods described herein. In some examples, aspects of the operations of 1120 may be performed by a split-screen manager as described with reference to FIGS. 6 through 9.

At 1125, the device may output an indication of the determined split-screen condition. The operations of 1125 may be performed according to the methods described herein. In some examples, aspects of the operations of 1125 may be performed by a split-screen manager as described with reference to FIGS. 6 through 9.

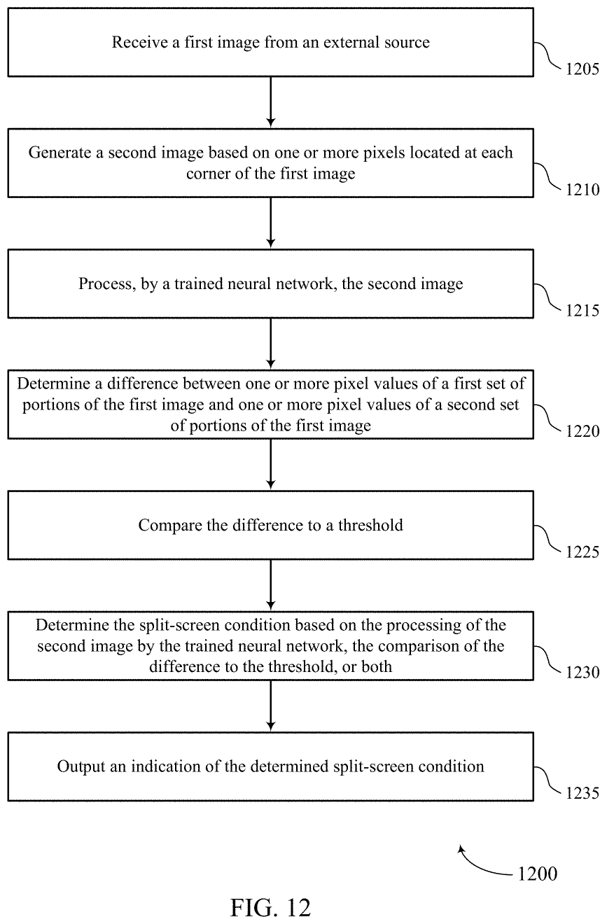

FIG. 12 shows a flowchart illustrating a method 1200 that supports detection of a split-screen condition in accordance with aspects of the present disclosure. The operations of method 1200 may be implemented by a device or its components as described herein. For example, the operations of method 1200 may be performed by a display manager as described with reference to FIGS. 6 through 9. In some examples, a device may execute a set of instructions to control the functional elements of the device to perform the functions described herein. Additionally or alternatively, a device may perform aspects of the functions described herein using special-purpose hardware.

At 1205, the device may receive a first image from an external source. The operations of 1205 may be performed according to the methods described herein. In some examples, aspects of the operations of 1205 may be performed by an external image manager as described with reference to FIGS. 6 through 9.

At 1210, the device may generate a second image based on one or more pixels located at each corner of the first image. The operations of 1210 may be performed according to the methods described herein. In some examples, aspects of the operations of 1210 may be performed by an external image manager as described with reference to FIGS. 6 through 9.

At 1215, the device may process, by a trained neural network, the second image. The operations of 1215 may be performed according to the methods described herein. In some examples, aspects of the operations of 1215 may be performed by a neural network manager as described with reference to FIGS. 6 through 9.

At 1220, the device may determine a difference between one or more pixel values of a first set of portions of the first image and one or more pixel values of a second set of portions of the first image. The operations of 1220 may be performed according to the methods described herein. In some examples, aspects of the operations of 1220 may be performed by a pixel difference manager as described with reference to FIGS. 6 through 9.

At 1225, the device may compare the difference to a threshold. The operations of 1225 may be performed according to the methods described herein. In some examples, aspects of the operations of 1225 may be performed by a pixel difference manager as described with reference to FIGS. 6 through 9.

At 1230, the device may determine the split-screen condition based on the processing of the second image by the trained neural network, the comparison of the difference to the threshold, or both. The operations of 1230 may be performed according to the methods described herein. In some examples, aspects of the operations of 1230 may be performed by a split-screen manager as described with reference to FIGS. 6 through 9.

At 1235, the device may output an indication of the determined split-screen condition. The operations of 1235 may be performed according to the methods described herein. In some examples, aspects of the operations of 1235 may be performed by a split-screen manager as described with reference to FIGS. 6 through 9.

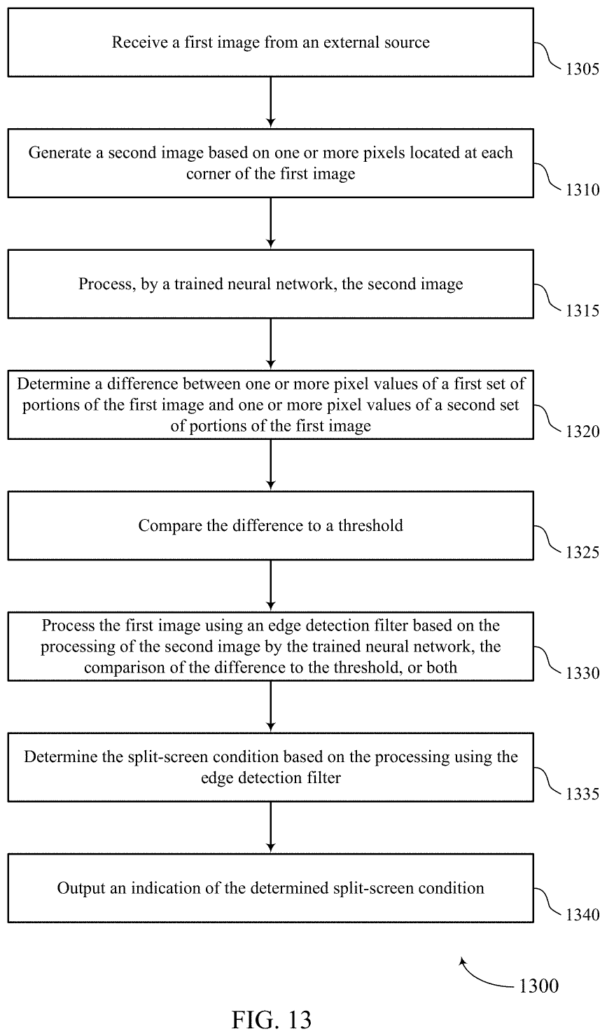

FIG. 13 shows a flowchart illustrating a method 1300 that supports detection of a split-screen condition in accordance with aspects of the present disclosure. The operations of method 1300 may be implemented by a device or its components as described herein. For example, the operations of method 1300 may be performed by a display manager as described with reference to FIGS. 6 through 9. In some examples, a device may execute a set of instructions to control the functional elements of the device to perform the functions described herein. Additionally or alternatively, a device may perform aspects of the functions described herein using special-purpose hardware.

At 1305, the device may receive a first image from an external source. The operations of 1305 may be performed according to the methods described herein. In some examples, aspects of the operations of 1305 may be performed by an external image manager as described with reference to FIGS. 6 through 9.

At 1310, the device may generate a second image based on one or more pixels located at each corner of the first image. The operations of 1310 may be performed according to the methods described herein. In some examples, aspects of the operations of 1310 may be performed by an external image manager as described with reference to FIGS. 6 through 9.

At 1315, the device may process, by a trained neural network, the second image. The operations of 1315 may be performed according to the methods described herein. In some examples, aspects of the operations of 1315 may be performed by a neural network manager as described with reference to FIGS. 6 through 9.

At 1320, the device may determine a difference between one or more pixel values of a first set of portions of the first image and one or more pixel values of a second set of portions of the first image. The operations of 1320 may be performed according to the methods described herein. In some examples, aspects of the operations of 1320 may be performed by a pixel difference manager as described with reference to FIGS. 6 through 9.

At 1325, the device may compare the difference to a threshold. The operations of 1325 may be performed according to the methods described herein. In some examples, aspects of the operations of 1325 may be performed by a pixel difference manager as described with reference to FIGS. 6 through 9.

At 1330, the device may process the first image using an edge detection filter based on the processing of the second image by the trained neural network, the comparison of the difference to the threshold, or both. The operations of 1330 may be performed according to the methods described herein. In some examples, aspects of the operations of 1330 may be performed by an edge detection manager as described with reference to FIGS. 6 through 9.

At 1335, the device may determine the split-screen condition based on the processing using the edge detection filter. The operations of 1335 may be performed according to the methods described herein. In some examples, aspects of the operations of 1335 may be performed by a split-screen manager as described with reference to FIGS. 6 through 9.

At 1340, the device may output an indication of the determined split-screen condition. The operations of 1340 may be performed according to the methods described herein. In some examples, aspects of the operations of 1340 may be performed by a split-screen manager as described with reference to FIGS. 6 through 9.

It should be noted that the methods described herein describe possible implementations, and that the operations and the steps may be rearranged or otherwise modified and that other implementations are possible. Furthermore, aspects from two or more of the methods may be combined. The described operations performed by a device may be performed in a different order than the order described, or the operations may be performed in different orders or at different times. Certain operations may also be left excluded or skipped, or other operations may be added. For example, a device may implement aspects of the techniques described herein as one or more stages (e.g., such as an image truncation stage, a neural network processing stage, a continuality analysis stage, an edge detection filter stage, etc.), where stages may be implemented separately, may be implemented together to confirm decision making or provide more robustness to split-screen detection, and may be implemented in any combination and order based on system needs, device capability, etc.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for image processing at a device, comprising:
receiving a first image from an external source;
generating a second image based at least in part on one or more pixels located at each corner of the first image;
processing, by a trained neural network, the second image;
determining a split-screen condition associated with the first image based at least in part on the processing; and
outputting an indication of the determined split-screen condition.

2. The method of claim 1, further comprising:
processing the first image using an edge detection filter, wherein the split-screen condition is determined based at least in part on the processing using the edge detection filter.

3. The method of claim 2, wherein processing the first image using the edge detection filter comprises:
converting pixels of one or more rows of the first image into white pixels;
appending the white pixels to one or more pixel arrays; and
comparing the one or more pixel arrays to a threshold, wherein the split-screen condition is determined based at least in part on the comparison.

4. The method of claim 3, wherein determining the split-screen condition comprises:
determining a vertical split-screen condition based at least in part on the comparison, wherein the output indication is indicative of the vertical split-screen condition.

5. The method of claim 2, wherein processing the first image using the edge detection filter comprises:
converting pixels of one or more columns of the first image into white pixels;
appending the white pixels to one or more pixel arrays; and
comparing the one or more pixel arrays to a threshold, wherein the split-screen condition is determined based at least in part on the comparison.

6. The method of claim 5, wherein determining the split-screen condition comprises:
determining a horizontal split-screen condition based at least in part on the comparison, wherein the output indication is indicative of the horizontal split-screen condition.

7. The method of claim 2, wherein:
determining the split-screen condition comprises: determining a horizontal split-screen condition associated with the first image, determining a vertical split-screen condition associated with the first image, or both; and
processing the first image using the edge detection filter comprises:
performing an edge detection operation on one or more columns of pixels of the first image,
performing an edge detection operation one or more rows of pixels of the first image, or both, based at least in part on the determined the split-screen condition.

8. The method of claim 2, further comprising:
verifying the trained neural network based at least in part on the processing the using the edge detection filter.

9. The method of claim 1, wherein the second image comprises four quadrants, and each of the quadrants comprises an array of one or more pixels from a respective corner of the first image.

10. The method of claim 1, wherein the split-screen condition is determined based at least in part on a power consumption threshold of the device, a frequency threshold associated with the split-screen condition determination, a severity threshold associated with the split-screen condition determination, or some combination thereof.

11. The method of claim 1, wherein determining the split-screen condition comprises:
determining a horizontal split-screen condition associated with the first image, a vertical split-screen condition associated with the first image, or both, wherein the output indication is indicative of the horizontal split-screen condition, the vertical split-screen condition, or both.

12. The method of claim 1, further comprising:
receiving one or more images from the external source; and
training the trained neural network based at least in part on the received one or more images.

13. The method of claim 1, further comprising:
receiving a retransmission of the first image from the external source based at least in part on the output indication of the determined split-screen condition, wherein the indication of the determined split-screen condition is output to the external source.

14. A method for image processing at a device, comprising:
receiving a first image from an external source;
determining a difference between one or more pixel values of a first set of portions of the first image and one or more pixel values of a second set of portions of the first image;
comparing the difference to a threshold;
determining a split-screen condition associated with the first image based at least in part on the comparing; and
outputting an indication of the determined split-screen condition.

15. The method of claim 14, wherein determining the difference between the one or more pixel values of the first set of portions of the first image and the one or more pixel values of the second set of portions of the first image comprises:
determining a sum of differences squared between the one or more pixel values of the first set of portions of the first image and the one or more pixel values of the second set of portions of the first image;
normalizing the determined sum of differences squared based at least in part on a dimension size of the first image; and
performing one or more convolution calculations based on at least in part on the normalized sum.

16. The method of claim 14, wherein determining the difference between the one or more pixel values of the first set of portions of the first image and the one or more pixel values of the second set of portions of the first image comprises:
determining a difference between one or more pixel values of a first set of one or more rows of the first image and one or more pixel values of a second set of one or more rows of the first image, wherein the determined split-screen condition comprises a horizontal split-screen condition.

17. The method of claim 14, wherein determining the difference between the one or more pixel values of the first set of portions of the first image and the one or more pixel values of the second set of portions of the first image comprises:
determining a difference between one or more pixel values of a first set of one or more columns of the first image and one or more pixel values of a second set of one or more columns of the first image, wherein the determined split-screen condition comprises a vertical split-screen condition.

18. The method of claim 14, further comprising:
receiving a retransmission of the first image from the external source based at least in part on the output indication of the determined split-screen condition.

19. The method of claim 14, further comprising:
processing the first image using an edge detection filter, wherein the split-screen condition is determined based at least in part on the processing using the edge detection filter.

20. An apparatus for image processing at a device, comprising:
a processor,
memory coupled with the processor; and
instructions stored in the memory and executable by the processor to cause the apparatus to:
receive a first image from an external source;
determine a difference between one or more pixel values of a first set of portions of the first image and one or more pixel values of a second set of portions of the first image;
compare the difference to a threshold;
determine a split-screen condition associated with the first image based at least in part on the comparing; and
output an indication of the determined split-screen condition.
